(19) United States
(12) Patent Application Publication
(10) Pub. No.: US 2013/0234638 A1
(43) Pub. Date: Sep. 12, 2013

(54) POWER CONVERTER FOR DRIVING SWITCHED RELUCTANCE MOTOR

(71) Applicant: Shouichi Tanaka, Nagoya (JP)

(72) Inventor: Shouichi Tanaka, Nagoya (JP)

(21) Appl. No.: 13/452,835

(22) Filed: Apr. 21, 2012

(30) Foreign Application Priority Data
Mar. 6, 2012 (JP) 2012-048906
Apr. 4, 2012 (JP) 2012-085172
Apr. 18, 2012 (JP) 2012-95387

(51) Int. Cl. H02P 6/14

(52) U.S. Cl. 318/400.27

(57) ABSTRACT

An upper bridge of the power converter drives a half of phase windings. A lower bridge of the power converter drives the other half of the phase windings. For example, an upper neutral point of a star-connected upper phase windings is connected to a lower neutral point of a star-connected lower phase windings via a connection switch. A current-absorbing leg absorbs a current from the upper neutral point. A current-supplying leg supplies a current to the lower neutral point. Preferably, the power converter has an asymmetric bridge mode, a dual Miller mode and an accelerated bridge mode by means of switching the connection switch, the current-absorbing leg and the current-supplying leg.

### CROSS-REFERENCE TO RELATED APPLICATION

This application claims benefit under 35 U.S.C. 119 of JP2012-048906 filed on Mar. 6, 2012, the title of TRANSVERSE FLUX MACHINE APPARATUS, JP2012-85172 filed on Apr. 4, 2012, the title of POWER CONVERTER FOR DRIVING SWITCHED RELUCTANCE MOTOR, JP2012-90645 filed on Apr. 12, 2012, the title of POWER CONVERTER FOR DRIVING SWITCHED RELUCTANCE MOTOR and JP2012-95387 filed on Apr. 19, 2012, the title of POWER CONVERTER FOR DRIVING SWITCHED RELUCTANCE MOTOR, the entire content of which is incorporated herein reference.

### BACKGROUND OF INVENTION

1. Field of the Invention

The present invention relates to a power converter for driving a switched reluctance motor, in particular a power converter for driving a switched reluctance motor having phase windings of four or six or more than six of even number.

2. Description of the Related Art

It is known for a switched reluctance motor (SRM) to have many advantages for a variable-speed application such as a traction motor, in particular a direct-drive hub motor. However, it is known for the SRM to have drawbacks such as acoustic noise, vibration, torque ripples and a torque/weight ratio in comparison with a popular permanent magnet synchronous motor. It is known that acoustic noise, vibration, torque ripples of the SRM is reduced by increasing phase number of the SRM. However, it is not easy for the power converter to increase the phase number because of a cost of the multi-phase power converter. Many circuit topologies of power converters are proposed for SRMs.

U.S. Pat. No. 7,906,931 describes a power converter with a full-bridge per phase. However, The full-bridge power converter requires four switches per phase. A popular asymmetric bridge converter shown in FIG. 1 requires two switches per phase. Three phase windings 3U, 3V and 3W are driven independently by the power converter having an upper bridge 9A and a lower bridge 9B. The upper bridge 9A has three legs consisting of upper switches T1, T3 and T5 and lower diodes D1, D3 and D5. The lower bridge 9B has three legs consisting of lower switches T2, T4 and T6 and upper diodes D2, D4 and D6.

FIG. 2 shows a Miller converter having less transistors. The Miller converter has a common leg 9c consisting of a switch T8 and a diode D8 instead of the lower bridge 9B shown in FIG. 1. However, the Miller converter cannot execute demagnetization of one phase and magnetization of another phase simultaneously. FIG. 3 shows an arranged Miller converter having a lower switch T8B instead of the diode D8 shown in FIG. 2. FIG. 4 shows a four-phase capacitor split power converter, which is one kind of a power converter using two voltage sources. The capacitor split converter has four switches T1-T4, four diodes and two capacitors C1 and C2. A neutral point N is connected to an upper DC link line 1000 via a pair of a X-phase winding 3X and an upper switch T1 or a pair of a Z-phase winding 3Z and an upper switch T3 or a capacitor C1. Further, the neutral point N is connected to a lower DC link line 2000 via a pair of a Y-phase winding 3Y and a lower switch T2 or a pair of a T-phase winding 3T or a lower switch T4 and a capacitor C2. Capacitors C1 and C2 keep a voltage of neutral point N to a half of a DC link voltage.

However, the voltage split four phase power converter shown in FIG. 4 needs voltage split capacitors C1 and C2 having a large capacity and a high cost due to apply a half of the DC link voltage to each phase windings 3X-3T.

A energy-absorber of a power converter is known. The energy-absorber has a capacitor for accumulating a demagnetizing current temporally. Typically, the energy-absorber connects each of upper diodes D2, D4 and D6 to a DC link. However, it is difficult to employ the energy absorber for the power converter of driving a large SRM because the capacitor having a large capacity under of high voltage type is large and expensive.

### CITATION LIST

### Patent Literature

PTL 1: U.S. Pat. No. 7,906,931

### SUMMARY OF INVENTION

An object of the invention is to provide a simple SRM drive capable of reducing acoustic noise, vibration and torque ripples of a multi-phase SRM. Another object of the invention is to provide a simple SRM drive capable of extending a speed range of a multi-phase SRM. Another object of the invention is to provide a simple SRM drive capable of increasing a torque/weight ratio. Another object of the invention is to provide a control method of a multi-phase SRM drive having benefits mentioned above.

As for the invention, a power converter having an upper bridge and a lower bridge, which are controlled by a controller, drives a switched reluctance machine having phase windings of four or six or more than six of even number. Each upper leg of the upper bridge is connected to each upper phase windings connected to an upper neutral point. Each lower leg of the lower bridge is connected to each lower phase windings connected to an lower neutral point. The upper leg has a pair of a lower switch and an upper diode connected in series. The lower leg has a pair of an upper switch and a lower diode connected in series. The upper neutral point is connected to the lower neutral point directly or via at least one of a connection switch and a connection diode.

The power converter further has a current-adjusting circuit having at least one transistor for adjusting a neutral current flowing from the upper neutral point to the lower neutral point. Therefore, it is capable of constructing the SRM with low acoustic noise, low vibration and low torque ripples without using an expensive power converter having many power transistors or a large voltage-split capacitors. It is known that acoustic noise, vibration and torque ripples are reduced by means of increasing phase number. The power converter having essentially one switch per phase is capable of driving a six-phase SRM because the transistor of the current-adjusting circuit adjusts phase currents.

According to a preferred embodiment, the upper bridge magnetize three of odd numbered stator poles to a first magnetic polarity, and the lower phase windings magnetize three of even numbered stator poles a second magnetic polarity. Therefore, an iron loss of the six-phase SRM is reduced because the SRM of radial flux type has short flux passages

According to another preferred embodiment, one phase current of one bridge with three legs is equal to a sum of two phase currents of another bridge with three legs in an asymmetric mode. Therefore, the simple power converter can drive the six-phase SRM.

According to another preferred embodiment, one bridge supplies an increasing current of one phase and a decreasing current of another phase. The other bridge supplies an essentially constant current of another phase in the asymmetric mode. Therefore, the simple power converter without voltage split capacitors can drive the six-phase SRM.

According to another preferred embodiment, the two bridges supply each phase current having an essentially trapezoid waveforms. Therefore, the current difference between the two bridges is reduced.

According to another preferred embodiment, the two bridges supply each phase current exciting each magnetic flux having essentially half rectified sinusoidal waveforms to each phase winding. For example, the two bridges supply each phase current having essentially half rectified sinusoidal waveforms. Or, the two bridges apply to each phase voltage having essentially half rectified sinusoidal waveforms to each phase winding. Therefore, the current difference between the two bridges is reduced. Moreover, acoustic noise, vibration are reduced. Further, an iron loss of the six-phase SRM is reduced. Similarly, other known SRMs, for example a three-phase SRM, can have a low iron loss by means of employing each phase magnetic flux having essentially half rectified sinusoidal waveforms. The reason that each phase currents having half rectified sinusoidal waveforms reduce the iron loss is explained hereinafter. A predetermined average value of phase current must be supplied for one magnetization period of a SRM in order to produce a predetermined average value of a motor torque. First, the phase current is increased from zero to a predetermined value, and the phase current is decreased from the predetermined value to zero. A hysterics loss is similar to a friction loss on the mechanics. The hysterics loss is increased, when a changing speed of magnetic flux and a magnetic flux density are high. The changing speed of the magnetic flux with half rectified sinusoidal waveforms is lower than the other waveforms, when the magnetic flux density is high. Therefore, the iron loss of a SRM is reduced, when the phase currents having the half rectified sinusoidal waveforms are supplied to the SRM. In other words, changing of the magnetic flux density is easy, when the magnetic flux density is low, but the changing of the magnetic flux density is difficult, when the magnetic flux density is high. Preferably, the phase currents with half rectified sinusoidal waveforms is supplied to a SRM, when a rotation speed of the SRM is high because the iron loss of a variable-speed SRM such as the traction motor is increased very much in the high speed area. It is capable of applying the phase voltages having essentially half rectified sinusoidal waveforms to phase windings of a SRM instead of supplying the phase currents having essentially half rectified sinusoidal waveforms.

According to another preferred embodiment, the current-adjusting circuit has a current-absorbing leg connected to the upper neutral point and a current-supplying leg connected to the lower neutral point. Therefore, voltage ripples of the neutral points are reduced even though a current difference between two bridges becomes large. Therefore, the current difference between the two bridges is compensated without the voltage split capacitors.

According to another preferred embodiment, the current-absorbing leg has a current-absorbing switch for absorbing the current from the upper neutral point. The current-supplying leg has a current-supplying switch for supplying the current to the lower neutral point. Therefore, the current difference between the two bridges is compensated without the voltage split capacitors.

According to another preferred embodiment, the current-absorbing switch and the current-supplying switch are switched in accordance with either of the voltage of the neutral points or a current difference between the upper bridge and the lower bridge in the accelerated bridge mode having an essentially equal voltage of the neutral points. The switches are switched in order to reduce the ripples of the voltage of the neutral points. Therefore, the current difference between the two bridges is reduced.

According to another preferred embodiment, the upper bridge and the current-absorbing leg constitutes one Miller converter in a dual Miller mode when the connection switch is turned off. Similarly, the lower bridge and the current-supplying leg constitutes the other Miller converter in the dual Miller mode. Therefore, a torque is increased in the dual Miller mode, because a full voltage of the DC power source is applied to two Miller converters each.

According to another preferred embodiment, the dual Miller mode is selected, when either of the two bridges has a trouble. Therefore, the reliability of the power converter is improved. According to another preferred embodiment, the dual Miller mode is selected, when a rotation speed of the SRM is a high speed area. Therefore, the SRM produces a sufficient torque in the high speed area even though the back electromagnetic force (EMF) is increased in the high speed area.

According to another preferred embodiment, the magnetizing mode and the demagnetizing mode of one bridge are executed alternately with a predetermined frequency in the dual Miller mode. Therefore, the magnetization speed and the demagnetization speed are improved.

According to another preferred embodiment, changing between the magnetizing mode and the demagnetizing mode is executed by means of switching the current-supplying switch and the current-absorbing switch. Therefore, the magnetization speed and the demagnetization speed are improved.

According to another preferred embodiment, each of phase current consists of a DC current component and a sinusoidal AC current component. An amplitude of the DC current component is essentially equal to an amplitude of the sinusoidal AC current component. Therefore, an iron loss is reduced in a high speed area.

### BRIEF DESCRIPTION OF DRAWINGS

FIG. 1 is a circuit topology configuration showing a prior three-phase asymmetric bridge converter.

FIG. 2 is a circuit topology configuration showing a prior three-phase Miller converter.

FIG. 3 is a circuit topology configuration showing an prior arranged three-phase Miller converter with a common half-bridge.

FIG. 4 is a circuit topology configuration showing a prior four-phase capacitor split power converter.

FIG. 5 is a circuit topology configuration showing a six-phase power converter of a first embodiment for driving a six-phase SRM.

FIG. 6 is a schematic side view showing a stator with twelve stator poles.

FIG. 7 is a schematic development showing a six-phase radial flux SRM of 12/14 type shown in FIG. 6.

FIG. 8 FIG. 8 is a timing chart showing waveforms of phase currents and inductances of the six-phase SRM shown in FIGS. 6 and 7.

FIG. 9 is a flow chart showing an operation of the power converter shown in FIG. 5.

FIG. 10 is a schematic side view showing a short flux passages in the SRM shown in FIG. 6.

FIG. 11 is a schematic side view showing the short flux passages in the SRM shown in FIG. 6.

FIG. 12 is a schematic axial cross-section showing a six-phase transverse flux switched reluctance machine having tandem structure.

FIG. 13 is a circumferential development showing arrangement of stator teeth of the six-phase TFSRM shown in FIG. 12.

FIG. 14 is a circumferential development showing arrangement of rotor teeth of the six-phase TFSRM shown in FIG. 12.

FIG. 15 is a timing chart showing waveforms of phase currents and inductances of an arranged six-phase SRM shown in FIG. 16.

FIG. 16 is a schematic development showing a six-phase radial flux SRM of 12/10 type.

FIG. 17 is a timing chart showing half rectified sinusoidal waveforms of another six-phase current for driving the six-phase SRM

FIG. 18 is a circuit topology configuration showing a six-phase power converter of a second embodiment for driving a six-phase SRM.

FIG. 19 is a timing chart showing waveforms of phase currents of the power converter driven with an accelerated bridge mode.

FIG. 20 is a circuit topology configuration showing a magnetization mode of a dual Miller mode in a first sub period.

FIG. 21 is a circuit topology configuration showing a demagnetization mode of the dual Miller mode in the first sub period.

FIG. 22 is a circuit topology configuration showing another magnetization mode of the dual Miller mode in a second sub period.

FIG. 23 is a circuit topology configuration showing another demagnetization mode of the dual Miller mode in the second sub period.

FIG. 24 is a timing chart showing a switching pattern of the power converter driven with the asymmetric bridge mode.

FIG. 25 is a timing chart showing a switching pattern of the power converter driven with the accelerated bridge mode.

FIG. 26 is a timing chart showing a switching pattern for the power converter driven with the dual Miller mode.

FIG. 27 is a flow chart showing one control example of power converter shown in FIG. 18.

FIG. 28 is a timing chart showing six phase currents having waveforms being equal each to a sum of a DC current and an AC current with a sinusoidal waveforms.

FIG. 29 is a flow chart for selecting a silent mode supplying the phase currents shown in FIG. 28.

FIG. 30 is a circuit topology configuration showing an arrangement of the power converter shown in FIG. 18.

FIG. 31 is a circuit topology configuration showing another arrangement of the power converter shown in FIG. 18.

FIG. 32 is a circuit topology configuration showing another arrangement of the power converter shown in FIG. 18.

FIG. 33 is a circuit topology configuration showing another arrangement of the power converter shown in FIG. 18.

FIG. 34 is a timing chart showing waveforms of phase currents and inductances of a three-phase SRM having six phase windings shown in FIG. 35.

FIG. 35 is a schematic development showing a three-phase SRM of 6/4 type having six phase windings connected to a neutral point each.

FIG. 36 is a schematic development showing a three-phase SRM of 6/8 type having six phase windings connected to a neutral point each.

FIG. 37 is a timing chart showing three-phase current supplied to the three-phase SRM having six phase windings shown FIG. 36.

FIG. 38 is a schematic axial cross-section showing a three-phase transverse tandem flux switched reluctance machine having two phase windings wound of the same phase.

FIG. 39 is a circumferential development showing arrangement of stator teeth of the three-phase TFSRM shown in FIG. 38.

FIG. 40 is a circumferential development showing arrangement of rotor teeth of the three-phase TFSRM shown in FIG. 38.

FIG. 41 is a circuit topology configuration showing a four-phase power converter of a third embodiment for driving a four-phase SRM.

FIG. 42 is a circuit topology configuration showing another four-phase power converter for driving the four-phase SRM.

FIG. 43 is a schematic timing chart showing inductances and currents in the asymmetric bridge mode of the four-phase power converter shown in FIGS. 41-42.

FIG. 44 is a schematic timing chart showing inductances and currents in the dual bridge mode of the four-phase power converter shown in FIGS. 41-42.

FIG. 45 is a circuit topology configuration showing a current-adjusting circuit operated in the asymmetric mode of the four-phase power converter shown in FIGS. 41-42.

### DETAILED DESCRIPTION OF THE PREFERRED EMBODIMENTS

### A First Embodiment

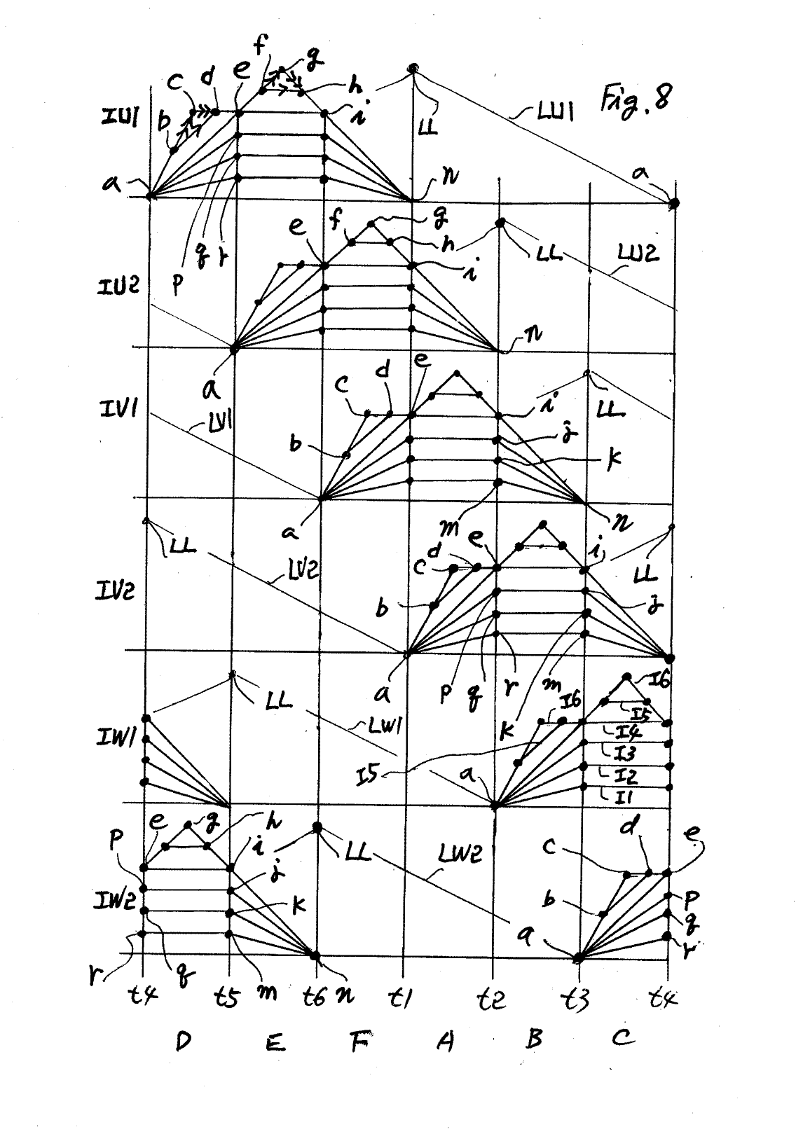

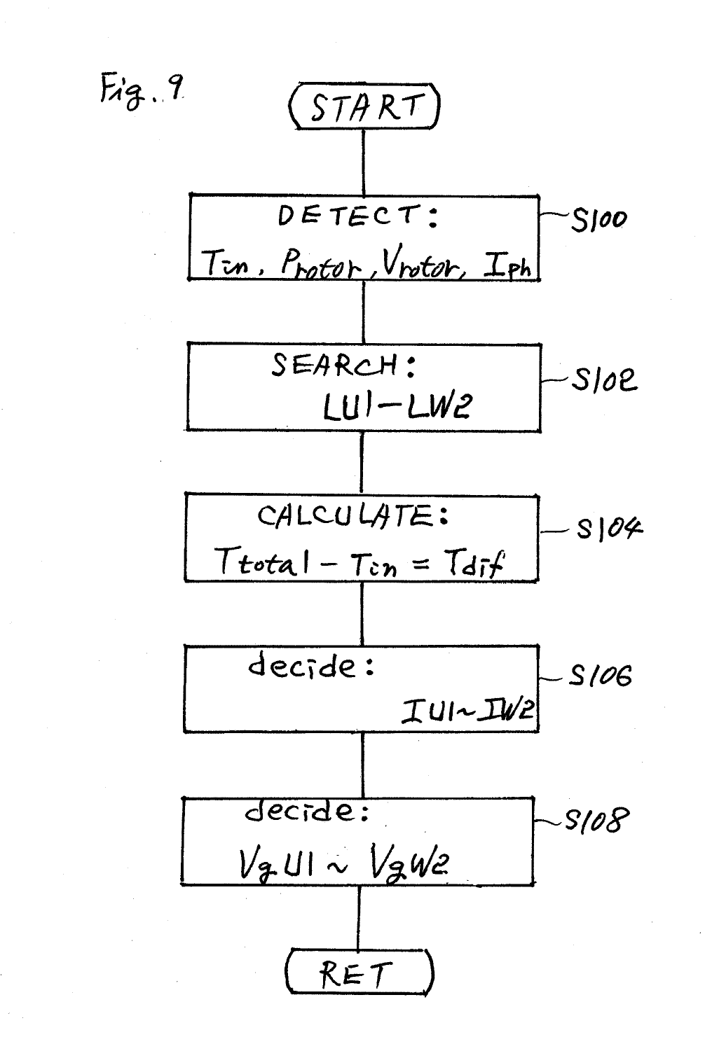

The first embodiment is explained referring to FIGS. 6-21. FIG. 6 is a circuit topology configuration showing a six-phase power converter 9 for driving a six-phase SRM having six phase windings 3U1-3W2 shown in FIGS. 7 and 8. FIG. 7 is a schematic cross-section showing one example of the six-phase SRM of 12/14 type. FIG. 8 is a schematic development showing a stator 2 having six stator poles 20 and a rotor 4 having seven rotor poles 40. The SRM shown in FIG. 7 has two sets of six phase windings 3U1-3W2 wound respectively on the six stator poles 20 in turn. The six phase windings 3U1-3W2 consist of the U1-phase windings 3U1, the U2-phase winding 3U2, the V1-phase windings 3V1, the V2-phase winding 3V2, the W1-phase windings 3W1 and the W2-phase winding 3W2.

The power converter 9 consists of an upper bridge 9A, a lower bridge 9B and a controller 300. The upper bridge 9A has a U1-phase leg 901, a V1-phase leg 903 and a W1-phase leg 905. The U1-phase leg 901 consists of an upper switch T1 and a lower diode D1 connected in series. The V1-phase leg 903 consists of an upper switch T3 and a lower diode D3 connected in series. The W1-phase leg 905 consists of an upper switch T5 and a lower diode D5 connected in series.

Upper ends of the upper switches T1, T3 and T5 are connected to a high potential DC link line 1000. Lower ends of the lower diodes D1, D3 and D5 are connected to a low potential DC link line 2000. A connection point of U1-phase leg 901 is connected to one end of the U1-phase winding 3U1. A connection point of V1-phase leg 903 is connected to one end of the V1-phase winding 3V1. A connection point of W1-phase leg 905 is connected to one end of the W1-phase winding 3W1. The other ends of the phase windings 3U1, 3V1 and 3W1 are connected to an upper neutral point NU.

The lower bridge 9B has a U2-phase leg 902, a V2-phase leg 904 and a W2-phase leg 906. The U2-phase leg 902 consists of a lower switch T2 and an upper diode D2 connected in series. The V2-phase leg 904 consists of an lower switch T4 and an upper diode D4 connected in series. The W2-phase leg 906 consists of a lower switch T6 and an upper diode D6 connected in series. Lower ends of the lower switches T2, T4 and T6 are connected to a low potential DC link line 2000. Upper ends of the upper diodes D2, D4 and D6 are connected to the high potential DC link line 1000. A connection point of U2-phase leg 902 is connected to one end of the U2-phase winding 3U2. A connection point of V2-phase leg 904 is connected to one end of the V2-phase winding 3V2. A connection point of W2-phase leg 906 is connected to one end of the W2-phase winding 3W2. The other ends of the windings 3U2, 3V2 and 3W2 are connected to a lower neutral point NL.

A star-connected upper three-phase winding 3k consists of three phase windings 3U1, 3V1 and 3W1. A star-connected lower three-phase winding 3L consists of three phase windings 3U2, 3V2 and 3W2. As shown in FIG. 6, three phase windings 3U1, 3V1 and 3W1 of the upper three-phase winding 3K are wound on odd numbered stator poles 20 respectively. Similarly, three phase windings 3U2, 3V2 and 3W2 of the lower three-phase winding 3L are wound on even numbered stator poles 20 respectively. Upper three-phase windings 3k magnetize odd numbered stator pole 20 to N-poles. Lower three-phase windings 3L magnetize even numbered stator pole 20 to S-poles.

A motor-driving method of power converter 9 is explained referring to FIG. 8. FIG. 8 is a timing chart showing six phase currents IU1-IW2 supplied to phase windings 3U1-3W2. In FIG. 8, each of the phase windings 3U1-3W2 has the largest inductance values LL of inductances LU1-LW2. At each point ‘a’ shown in FIG. 8, inductances LU1-LW2 have the smallest inductance value each.

The U1-phase current IU1 flows from the leg 901 to U1-phase winding 3U1. The V1-phase current IV1 flows from the leg 903 to V1-phase winding 3V1. The W1-phase current IW1 flows from the leg 905 to W1-phase winding 3W1. The U2-phase current IU2 flows from U2-phase winding 3U2 to the leg 902. The V2-phase current IV2 flows from V2-phase winding 3V2 to the leg 904. The W2-phase current IW2 flows from W2-phase winding 3W2 to the leg 906.

In FIG. 8, each phase has a magnetization period, a demagnetizing period and an absent period executed in turn. Each magnetization period starts at the time point ‘a’ and finishes at a time point ‘g’. Each demagnetization period starts at the time point ‘g’ and finishes at a time point ‘n’. Each magnetization period consists of a current-increasing period and a constant current period. Each of the current-increasing periods starts at time point ‘a’ and finishes at time points ‘e, p, q, r’. Each of the constant current periods starts at time points ‘e, p, q, r’ and finishes at time point ‘g’.

Each real line passing on time points ‘a, r, m and n’ shows each phase current having a current amplitude I1. Each real line passing on time points ‘a, q, k and n’ shows each phase current having a current amplitude I2. Each real line passing on time points ‘a, p, j and n’ shows each phase current having a current amplitude I3. Each real line passing on time points ‘a, e, i and n’ shows each phase current having a current amplitude I4. Each real line passing on time points ‘a, b, d, e, f, h, i and n’ shows each phase current having a current amplitude I5. Each real line passing on time points ‘a, b, c, d, e, f, g, h, i and n’ shows each phase current having a current amplitude I6.

Each of phase currents IU1-IW2 increases in each current-increasing period. However, phase currents IU1-IW2 with the amplitudes I5 and I6 have a part of the constant current period in the current-increasing period from the time point ‘a’ to the time point ‘e’. Each of phase currents IU1-IW2 is mostly constant in each constant current period from the points ‘e, p, q, and r’ to the points ‘i, j, k, and m’. However, phase currents IU1-IW2 with the amplitudes I5 and 16 are not constant in the constant current period from the point ‘e’ to the time point ‘i’. Each of phase currents IU1-IW2 decreases in each current-decreasing period from the points ‘i, j, k, and m’ to the point ‘n’.

Each current-increasing periods has sixty degrees of electric angle. Each of constant-current periods has sixty degrees of electric angle. Each of current-decreasing periods has sixty degrees of electric angle. Each phase difference between adjacent two phase currents has sixty degrees of electric angle. It is important that a sum of an increasing phase current in the current-increasing period and a decreasing phase current in the current-decreasing current is equal to a constant current in the constant current period.

Phase currents IU1-IW2 is supplied by means of PWM-switching the switches T1-T6. In a first case, switches T1-T6 are PWM-switched in the current-increasing periods and the constant current periods. In a second case, switches T1-T6 are PWM-switched in the current-increasing periods and the current-decreasing periods. It should be considered that the real lines 11-16 shown in FIG. 8 show schematic current configurations. Further, the real lines passing on the time point ‘i’ shows the largest demagnetizing current passing through diodes D1-D6.

Therefore, phase current IW2 becomes equal to a sum of phase currents IU1 and IW1 in a sub period ‘A’ from a time point t4 to a time point t5. Phase current IU1 becomes equal to a sum of phase currents IW2 and IU2 in a sub period ‘B’ from a time point t5 to a time point t6. Phase current IU2 becomes equal to a sum of phase currents IU1 and IV1 in a sub period ‘C’ from a time point t6 to a time point t1. Phase current IV1 becomes equal to a sum of phase currents IU2 and IV2 in a sub period ‘D’ from a time point t1 to a time point t2. Phase current IV2 becomes equal to a sum of phase currents IV1 and IW1 in a sub period ‘E’ from a time point t2 to a time point t3. Phase current IW1 becomes equal to a sum of phase currents IV2 and IW2 in a sub period ‘F’ from a time point t3 to a time point t4.

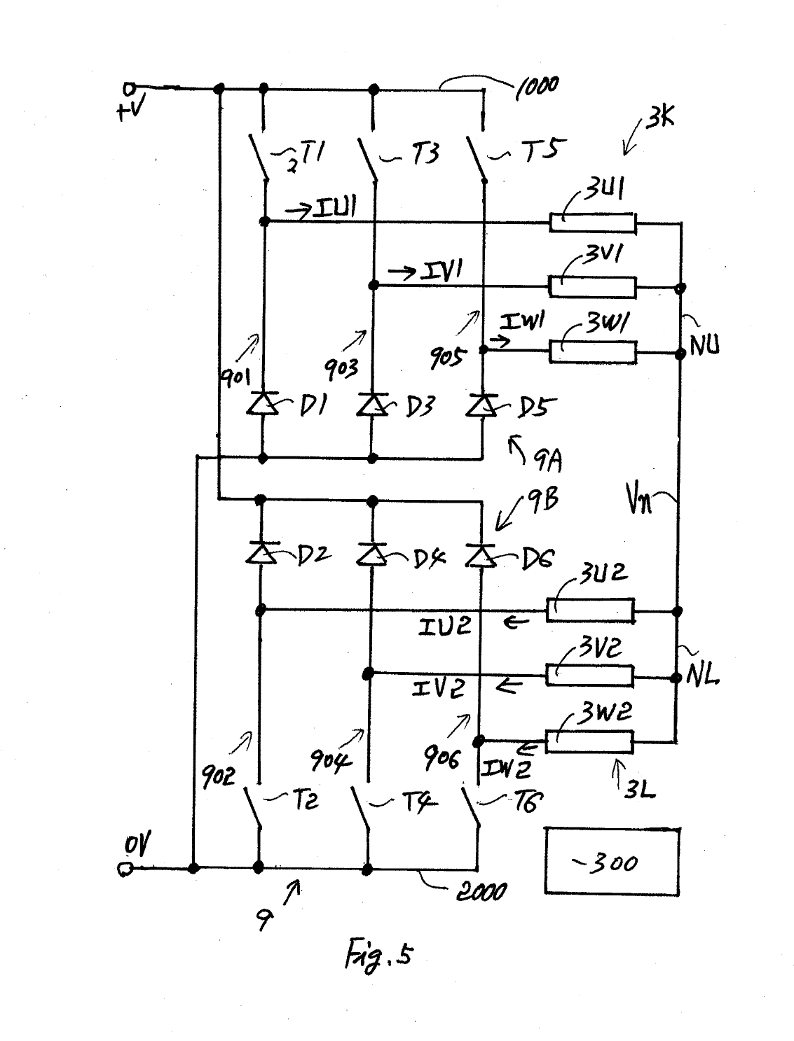

After all, it is considered that a voltage of the neutral points NU and NL becomes a half of DC link voltage continuously, when two of six switches T1-T6 are PWM-switched in order to accord the phase current in the constant-current period to a sum of the adjacent two phase currents in the current-increasing period and the current-decreasing period. As the result, the large capacitors C1 and C2 shown in FIG. 4 are abbreviated or becomes very small. Moreover, power converter 9 having only six switches T1-T6 can drives a six-phase SRM with low acoustic noise and low vibration.

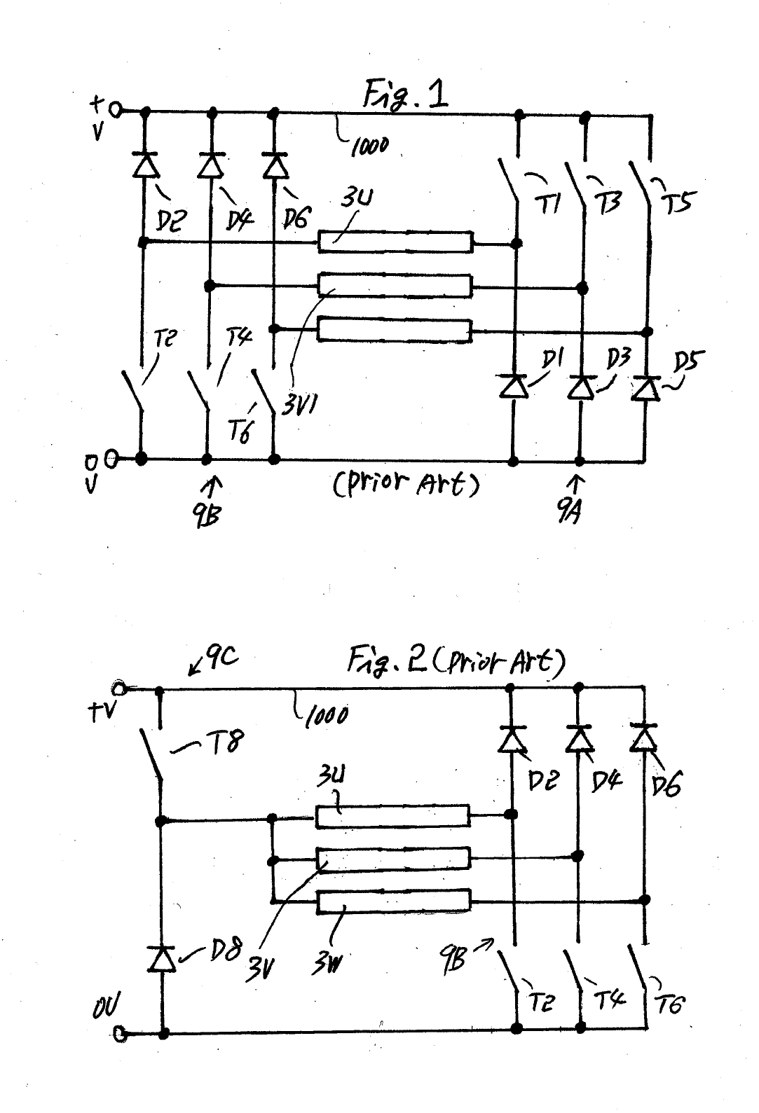

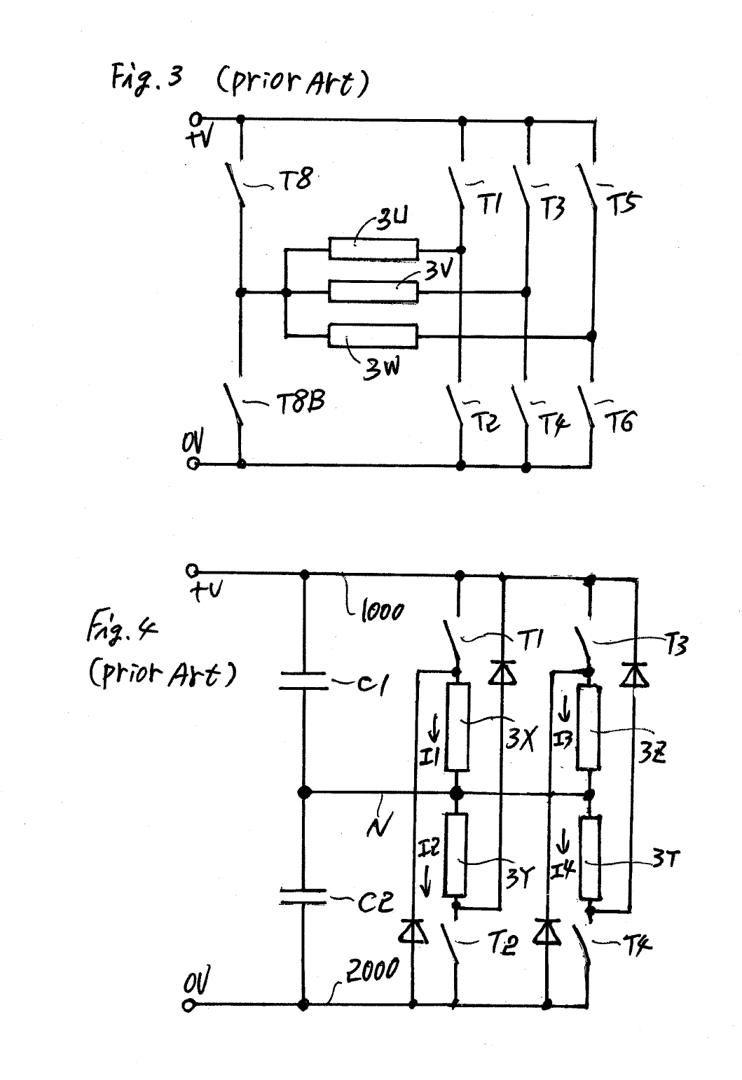

Accordingly, the simple power converter 9 reduces the acoustic noise, the vibration and the torque ripples largely because magnetic force between stator 2 and rotor 4 are dispersed spatially and sequentially. Further, power converter 9 supplies three phase currents simultaneously by means of PWM-switching only two of switches T1-T6. Therefore, the switching power loss of power converter 9 is reduced. Furthermore, power losses of diodes D1-D6 are reduced because the demagnetizing current flows through only one diode. In prior arts shown in FIG. 1-2, the demagnetizing current flows through two diodes in turn.

FIG. 9 is a flow chart showing the switch control. First, information for controlling the SRM is detected at a step S100. The information includes an torque instruction value Tin, a rotor position Protor, a rotor speed Vrotor and phase currents IU1-IW2. At next step S102, inductances LU1-LW2 is searched from a memorized map showing a relation between the phase inductance LU1-LW2, phase currents IU1-IW2 and the rotor position Protor. At next step S104, phase torques TU1-TW2 are calculated in accordance with phase currents IU1-IW2, phase inductances LU1-LW2 and the rotor speed Vrotor. Then, a total torque Ttotal is calculated in accordance with six phase torques TU1-TW2.

Further, a torque difference Tdif between the total torque Ttotal and the torque instruction value Tin is calculated. At next step S106, next values of phase currents IU1-IW2 are decided in accordance with torque difference Tdif and the detected phase currents IU1-IW2. At next step S108, gate voltages of switches T1-T9 are decided in accordance with next phase currents IU1-IW2. Instead of the above soft feedback operation, a hard feedback operation can be adopted.

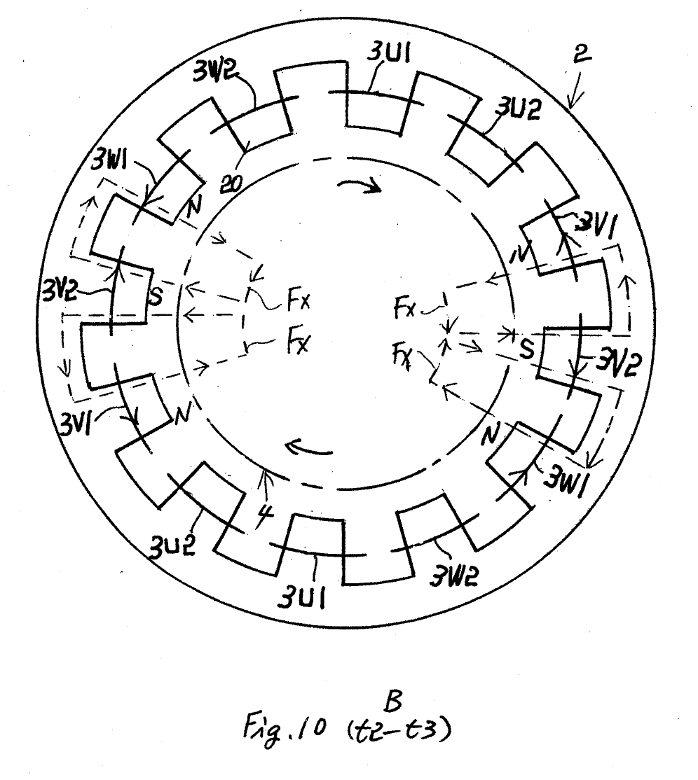

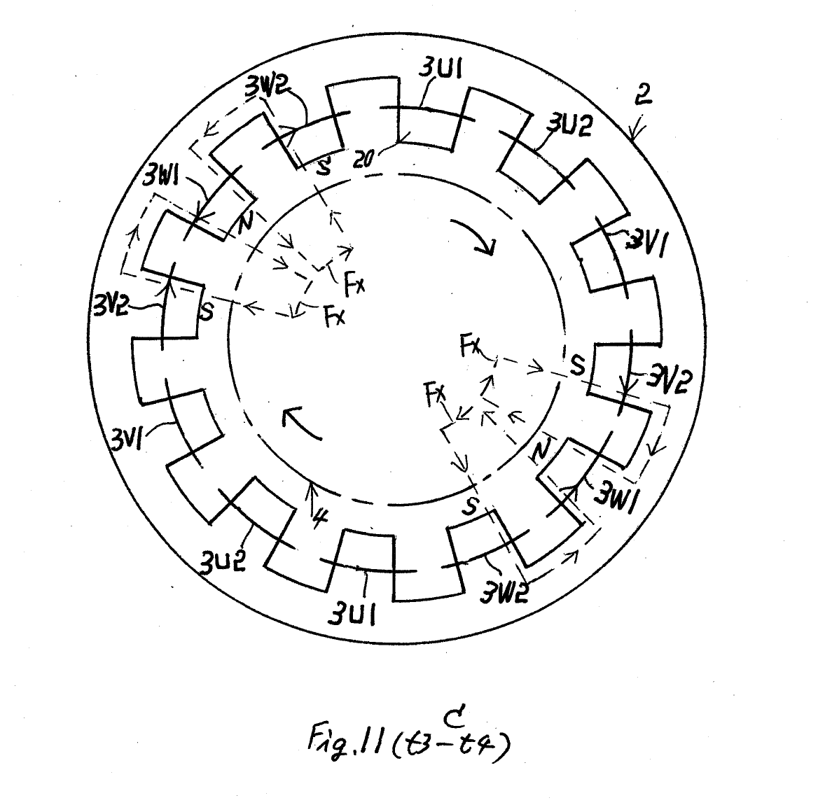

FIG. 10 is a schematic side view showing magnetic flux Fx of the six-phase SRM in the sub period B having sixty degrees of electric angle. FIG. 12 is a schematic side view showing the magnetic flux Fx in the sub period C having sixty degrees of electric angle. The magnetized odd numbered stator poles 20 have N-poles. The magnetized even numbered stator poles 20 have S-poles. Magnetic flux Fx circulate via adjacent only two stator poles 20 by employing the three phase currents supplied simultaneously. In other words, the six-phase SRM shown in FIGS. 10 and 11 becomes so-called the short flux path SRM without employing special core structure. Therefore, an iron loss is reduced largely. Instead of a conventional six-phase SRM of 12/14 type, another known six-phase is SRM, for example a six-phase SRM with U-shaped segmented rotor cores or a six-phase SRM with U-shaped segmented stator cores can be employed.

### A First Arranged Embodiment

The first arranged embodiment is explained referring to FIGS. 12-14. FIG. 12 is a schematic cross-section showing another six-phase transverse flux switched reluctance machine (TFSRM) having six single-phase TFSRMs arranged in tandem to an axial direction AX. Each of the six single-phase TFSRMs has each of rotor cores 4U1-4W2 facing to each of stator cores 2U1-2W2. Each of the rotor cores 4U1-4W2 has the left teeth 40L and the right teeth 40R connected with a ring-shaped back core. Each of the stator cores 2U1-2W2 has the left teeth 20L and the right teeth 20R connected with a ring-shaped back core. Each of ring-shaped phase windings 3U1-3W2 is accommodated in each ring-shaped slot formed between each pair of the left stator teeth 20L and the right stator teeth 20R. The left rotor teeth 40L face the left stator teeth 20L in the radial direction RA. The right rotor teeth 40R face the right stator teeth 20R in the radial direction RA.

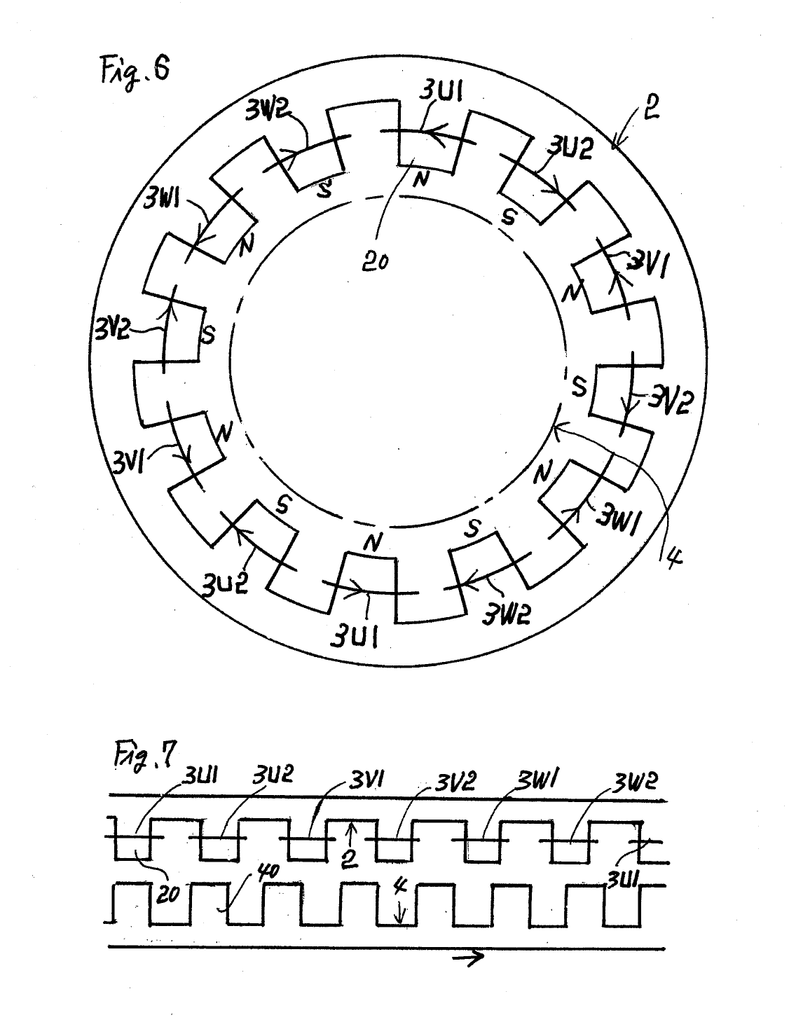

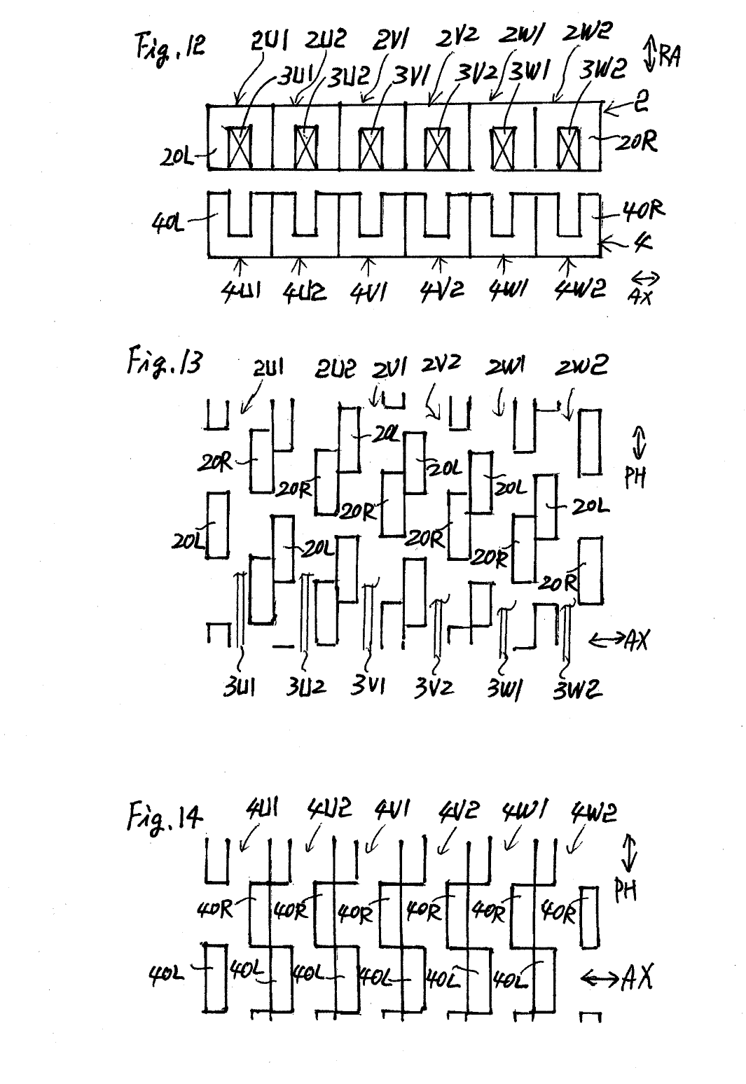

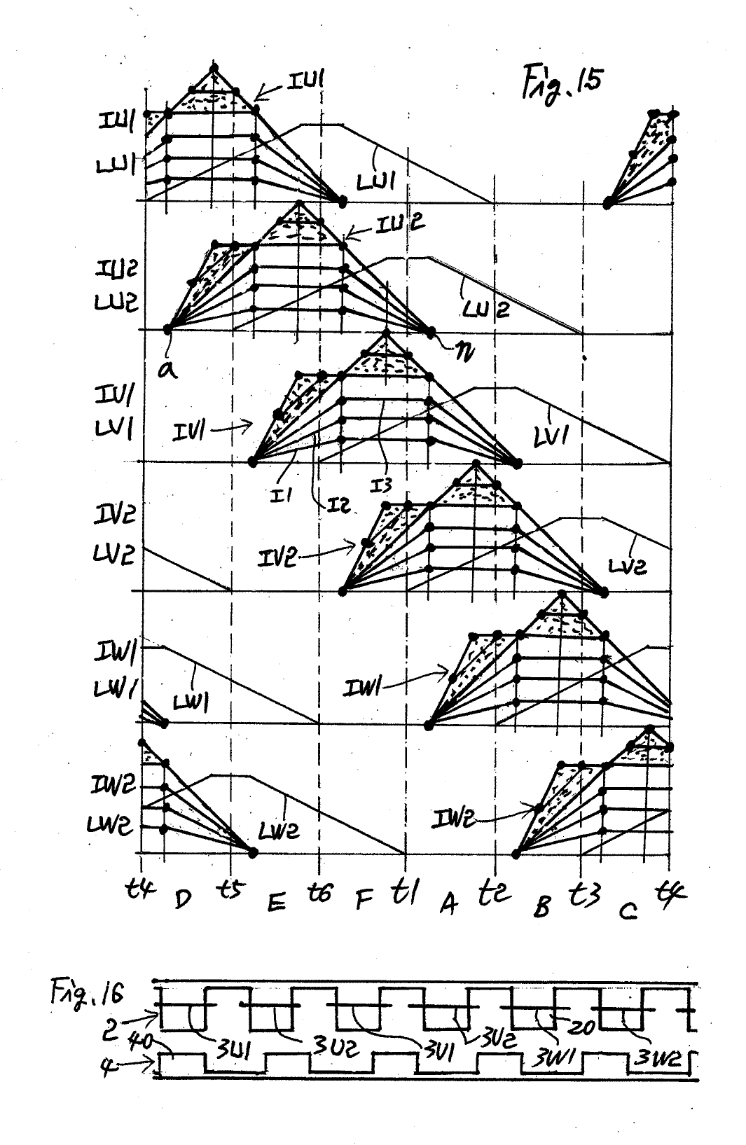

FIG. 13 is a circumferential development showing arrangement of stator teeth 20L and 20R. FIG. 14 is a circumferential development showing arrangement of rotor teeth 40L and 40R. The left stator teeth 20L, the right stator teeth 20R, the left rotor teeth 40L and the right rotor teeth 40R are arranged to the circumferential direction PH each. The power converter 9 shown in FIG. 5 can drive the six-phase TFSRM shown in FIGS. 12-14. Configurations of currents IU1-IW2 and inductances LU1-LW2 are shown in FIG. 8.

### A Second Arranged Embodiment

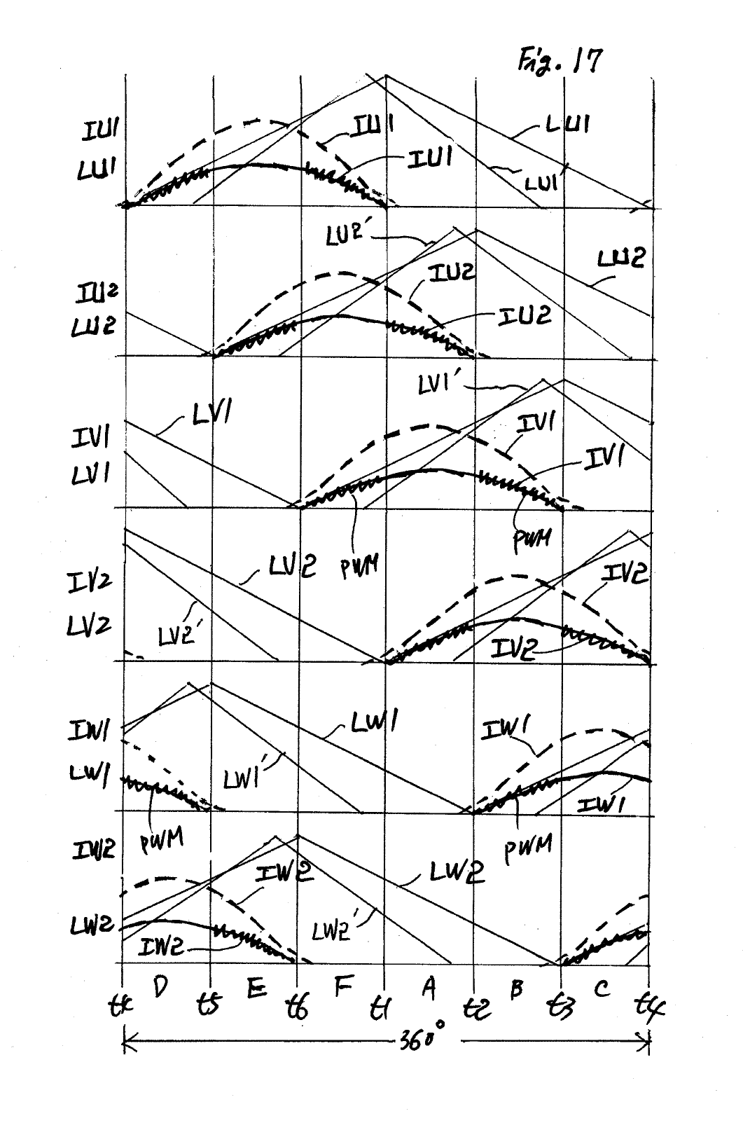

The second arranged embodiment is explained referring to FIGS. 15 and 16. FIG. 15 is a timing chart showing another six-phase SRM shown in FIG. 16. The six-phase 12/10 SRM shown in FIG. 16 has twelve stator poles per ten rotor poles. Six phase currents IU1-IW2 shown in FIG. 15 are same as six phase currents IU1-IW2 shown in FIG. 8. However, inductances LU1-LW2 shown in FIG. 16 have different configurations from inductances LU1-LW2 shown in FIG. 8 because a number of rotor poles 40 are different to each other.

### A Third Arranged Embodiment

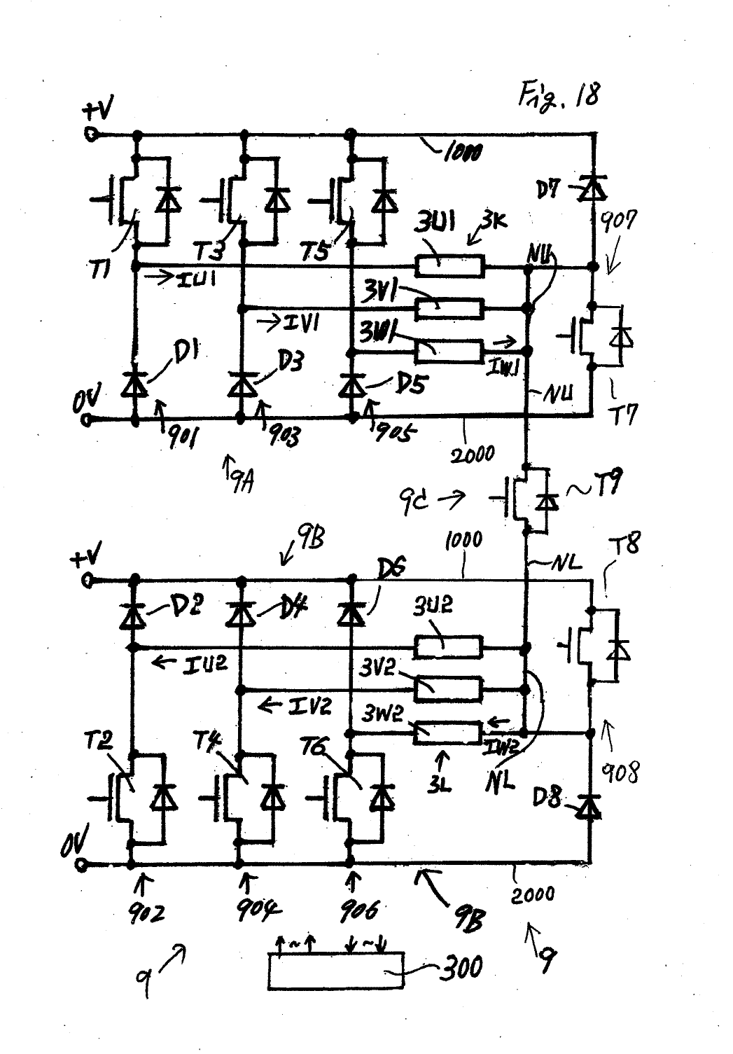

The third arranged embodiment is explained referring to FIG. 17. FIG. 17 is a timing chart showing another example of six phase currents IU1-IW2. Real lines show phase currents IU1-IW2 with small amplitude. Broken lines show phase currents IU1-IW2 with large amplitude. Six inductances LU1-LW2 show the inductances of phase windings 3U1-3W2 of six-phase SRM shown in FIGS. 6-14. Six inductances LU1′-LW2′ show the inductances of phase windings 3U1-3W2 of six-phase SRM shown in FIGS. 15-16. Each of phase currents IU1-IW2 has a positive half of sinusoidal waveform each. U1-phase current IU1 only flows from time point t4 to time point t1. U2-phase current IU2 flows from time point t5 to time point t2. V1-phase current IV1 flows from time point t6 to time point t3. V2-phase current IV2 flows from time point t1 to time point t4. W1-phase current IW1 flows from time point t2 to time point t5. W2-phase current IW2 flows from time point t3 to time point t6.

In sub period D, phase current IW2 is equal to a sum of phase currents IU1 and IW1. In sub period E, phase current IU1 is equal to a sum of phase currents IW2 and IU2. In sub period F, phase current IU2 is equal to a sum of phase currents IU1 and IV1. In sub period A, phase current IV1 is equal to a sum of phase currents IW2 and IV2. In sub period B, phase current IV2 is equal to a sum of phase currents IV1 and IW1. In sub period C, phase current IW1 is equal to a sum of phase currents IV2 and IW2. Therefore, vibration and acoustic noise are reduced. The configurations of phase current IU1-IW2 are formed by means of PWM-switching of two phases.

Furthermore, an iron loss is reduced largely by means of employing the phase currents IU1-IW2 having the half rectified sinusoidal waveforms each. In the prior SRM-driving method, it is unknown to drive a switched reluctance motor (SRM) with phase currents having the half rectified sinusoidal waveforms each. Further, it is unknown to reduce the iron loss by means of driving the SRM with phase currents having the half rectified sinusoidal waveforms each. It is desirable to supply the phase currents with the half rectified sinusoidal waveforms to a SRM rotating in a high speed area because the iron loss is reduced largely in the high speed area. Similarly, an iron loss of the other known SRM is reduced by means of employing the phase currents with the half rectified sinusoidal waveforms. It is capable of applying phase voltages with the half rectified sinusoidal waveforms to phase windings of a SRM in order to supply phase currents having essentially half rectified sinusoidal waveforms to the phase windings of the SRM. Moreover, it is capable of modulating each phase current in accordance with non-linear magnetic characteristic of the magnet core in order to excite each phase magnetic flux having essentially half rectified sinusoidal waveforms.

### A Second Embodiment

The second embodiment is explained referring to FIGS. 18-32. FIG. 18 is a circuit topology configuration showing another six-phase power converter 9. The power converter 9 shown in FIG. 18 is essentially same as power converter 9 shown in FIG. 5 except a neutral voltage controller 9C shown in FIG. 18. The neutral voltage controller 9C shown in FIG. 18 consists of a connection switch T9, a current-absorbing leg 907 and a current-supplying leg 908.

The connection switch T9 connects the upper neutral point NU of the upper three-phase winding 3K to the lower neutral point NL of the lower three-phase winding 3L. The current-absorbing leg 907 has a current-absorbing diode D7 and a current-absorbing switch T7 connected in series. A cathode electrode of the current-absorbing diode D7 is connected to the high potential DC link line 1000. An anode electrode of current-absorbing diode D7 is connected to upper neutral point NU. The current-absorbing switch T7 connects the upper neutral point NU to the low potential DC link line 2000.

The current-supplying leg 908 has a current-supplying switch T8 and a current-supplying diode D8 connected in series. The current-supplying switch T8 connects lower neutral point NL to the high potential DC link line 1000. An anode electrode of the current-supplying diode D8 is connected to low potential DC link line 2000. An cathode electrode of current-supplying diode D8 is connected to lower neutral point NL.

The controller 300 controls motor-driving operation of power converter 9. Controller 300 has three motor-driving modes, which are called an asymmetric bridge mode, an accelerated bridge mode and a dual Miller mode. The asymmetric bridge mode is executed, when the connection switch T9 is turned on, and the switch T7 and T8 are turned off. Therefore, the asymmetric bridge mode is same as the motor operation explained referring to FIGS. 5-17.

(The Accelerated Bridge Mode)

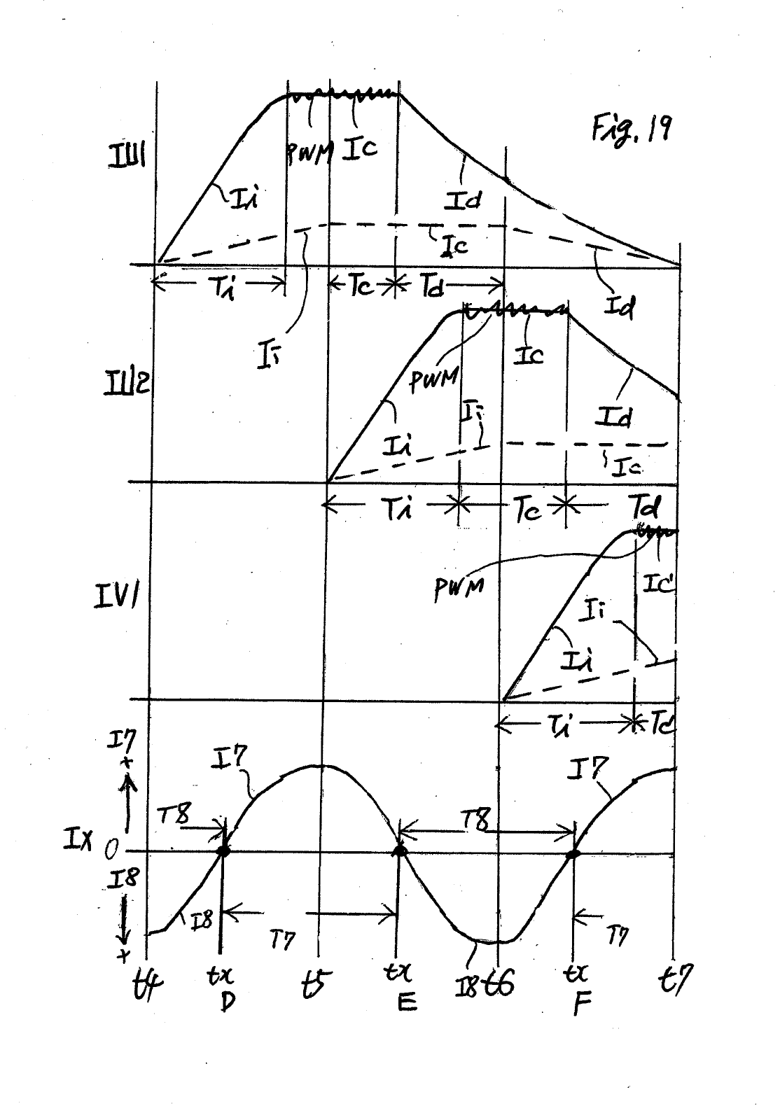

The accelerated bridge mode is explained referring to FIG. 19. In the accelerated bridge mode, the connection switch T9 is turned on. Further, either of the current-absorbing switch T7 and the current-supplying switch T8 is turned-on in order to reduce a difference between the constant current Ic and the sum of the increasing current Ii and the decreasing current Id. In other words, either of the switches T7 and T8 is turned-on in order to reduce a difference between a second-phase current and a sum of a first-phase current and a third-phase current. The difference between the second-phase current and the sum of the first-phase current and the third-phase current is equal to either of a current I7 of the switch T7 and a current I8 of the switch T8. Either of the switches T7 and T8 is PWM-switched in order to accord either of the currents I7 and I8 with the difference between the second-phase current and the sum of the first-phase current and the third-phase current. Therefore, power converter 9 is capable of supplying phase currents IU1-IW2 with a large amplitude in order to produce a large torque.

According to the accelerated bridge mode, the current difference between upper bridge 9A and lower bridge 9B is absorbed by means of PWM-switching either of current-absorbing switch T7 and current-supplying switch T8. Therefore, the current difference between upper bridge 9A and lower bridge 9B is absorbed by either of currents I7 and I8.

FIG. 19 is a timing chart showing three phase currents IU1, IU2 and IW2 in sub periods D-F. Real lines show three phase currents IU1, IU2 and IW2 with large amplitudes. Broken lines show three phase currents IU1, IU2 and IW2 with small amplitudes. For example, the increasing currents Ii of phase currents IU1, IU2 and IW2 are supplied with the so-called one-pulse method or the single-pulse method. In the one-pulse method, a one-pulse of the gate voltage is applied to a gate electrode of switches.

The PWM-switching method can be employed instead of the one pulse method. It is considered that the difference between U2-phase current IU2 and the sum of U1-phase current IU1 and V1-phase current IV1 becomes zero by means of PWM-switching of the increasing current of V1-phase current IV1 in sub period F. However, the current difference Ix between U2-phase current (the second phase current) IU2 and the sum of U1-phase current (the first phase current) IU1 and V1-phase current (the third phase current) IV1 has large ripples in the large current operation. The controller 300 calculates the current difference Ix in accordance with the memorized map and the detected information, and supplies the current difference Ix to phase windings 3U1-3W2 by means of PWM-switching current-absorbing T7 and current-supplying switch T8. In FIG. 19, the switch T7 is PWM-switched in periods T7. The switch T8 is PWM-switched in periods T8. At time points Tx, the current difference Ix becomes zero.

A feedback control method can be employed in order to control the switches T7 and T8. Switch T7 is turned on, when a sum of phase currents IU1, IV1 and IW1 is larger than a sum of phase currents IU2, IV2 and IW2. Similarly, switch T8 is turned on, when the sum of phase currents IU1, IV1 and IW1 is smaller than the sum of phase currents IU2, IV2 and IW2.

According to a preferred embodiment executing the accelerated bridge mode, the switches T7 and T8 can be switched with the feed back control method in accordance with a neutral voltage of neutral points NU and NL in order to keep the neutral voltage to a half of the DC link voltage. The switch T7 is turned on when the neutral voltage becomes higher than a half of the DC link voltage. Similarly, the switch T8 is turned on when the neutral voltage becomes lower than the half of the DC link voltage.

(The Dual Miller Mode)

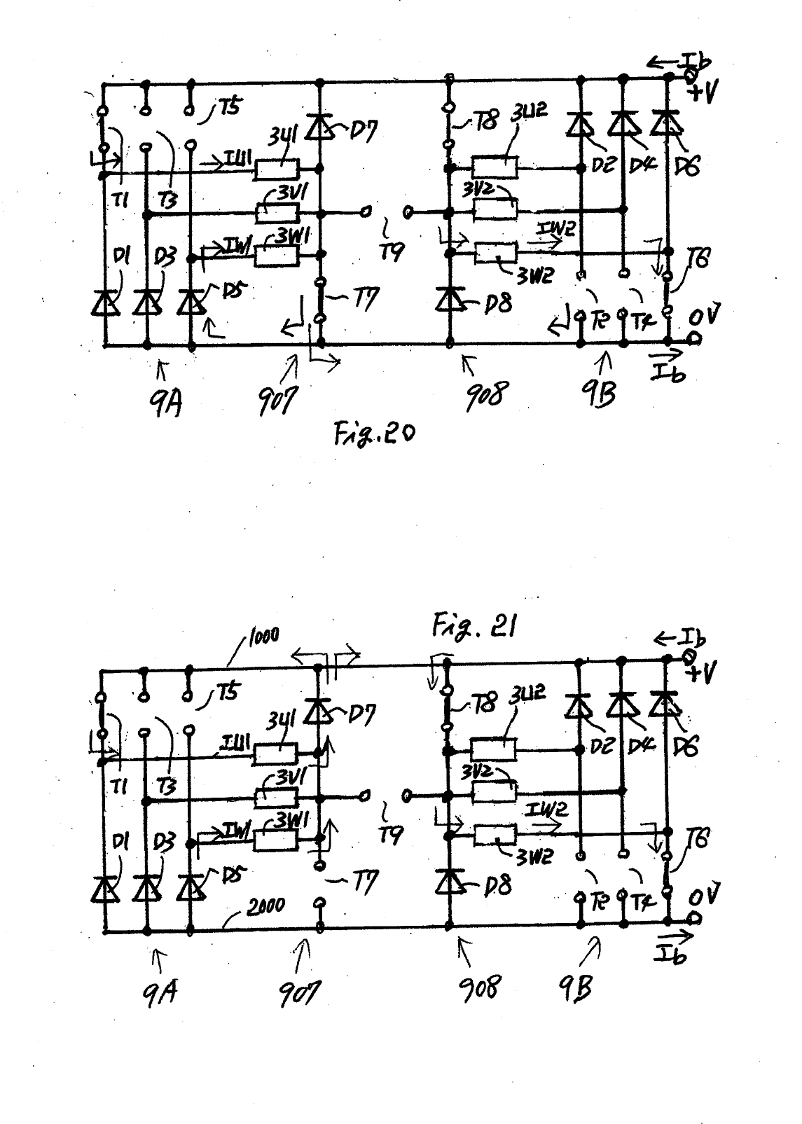

The dual Miller mode of the motor-driving operation is explained referring to FIGS. 20-23. According to the dual Miller mode, connection switch T9 is turned off. In other words, a pair of upper bridge 9A and current-absorbing leg 907 constitutes a first Miller converter. Another pair of lower bridge 9B and current-supplying leg 908 constitutes a second Miller converter.

The fundamental motor operation of the Miller converter is explained again referring to FIG. 2. In the magnetizing period, the magnetizing current of one phase flows by means of the turning-on of the switch T8 and one of switches T2, T4, T6. In the magnetizing period, a freewheeling current of another phase flows through the switch T8 and another of diodes D2, D4 and D6, when the demagnetization of another phase in not completed yet. In the demagnetizing period, the demagnetizing current of one phase flows by means of turning-off all switches T2, T4, T6 and T8. The magnetizing period of one phase and the demagnetization period of another phase cannot be overlapped to each other. Thus, the conventional Miller mode has a drawback that the demagnetization of the freewheeling current is slow in a low speed area because the back EMF is small.

FIGS. 20 and 21 show phase currents IU1, IW1 and IW2 in the sub period D shown in FIG. 9. FIG. 20 shows the magnetization mode executed in sub period D. The switches T1, T7, T6 and T8 are turned on. The magnetizing current IU1 flows through U1-phase winding 3U1 via the switches T1 and T7. The freewheeling current IWI circulates through W1-phase winding 3W1 via diode D5 and switch T7. The constant current IW2 flows through W2-phase winding 3W2 via the switches T6 and T8.

FIG. 21 shows the demagnetization mode executed in sub period D. The switches T8 and T6 are turned on, and the switch T7 is turned off. The demagnetizing current IW1 charges the DC power source (not shown) via DC link lines 1000 and 2000. Decreasing of the freewheeling current IU1 is slow. The constant current IW2 flows through W2-phase winding 3W2 via the switches T6 and T8. The magnetization modes and the demagnetization modes in sub periods F and B are essentially same as the magnetization mode and the demagnetization mode in sub periods D explained above.

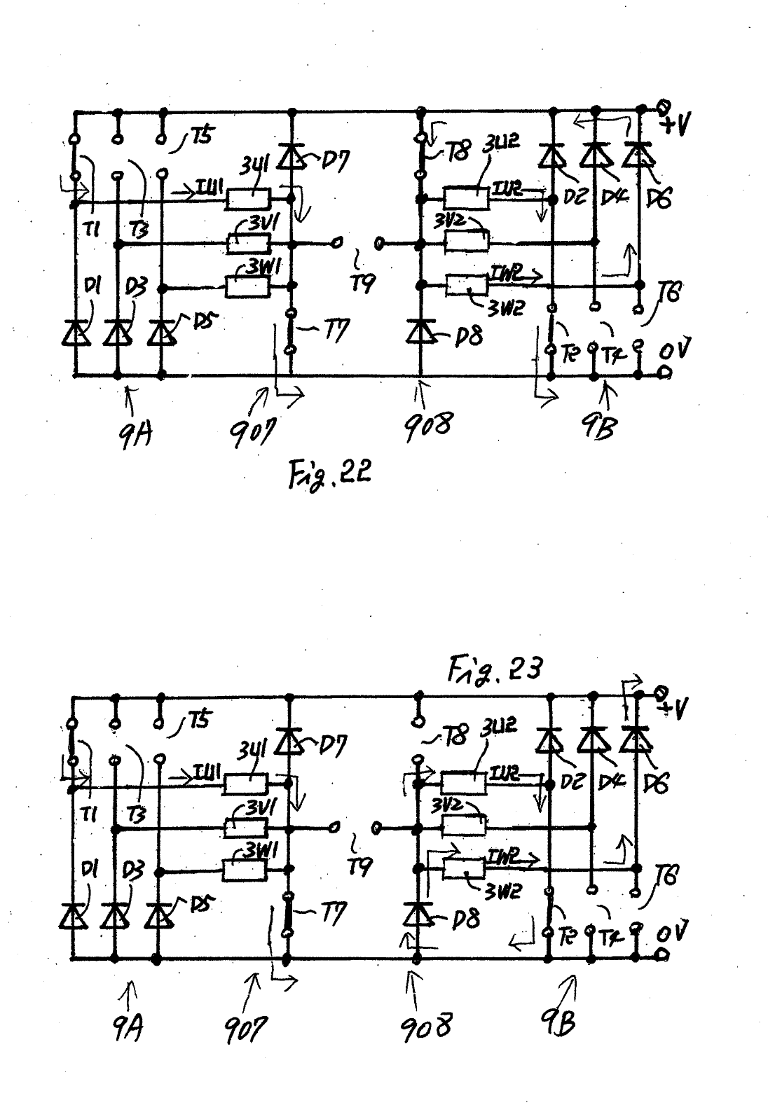

FIGS. 22 and 23 show phase currents IU1, IU2 and IW2 in sub period E. FIG. 22 shows the magnetization mode in sub period E. In FIG. 22, the switches T1, T2, T7 and T8 are turned on. The magnetizing current IU2 flows through U2-phase winding 3U2 via the switches T2 and T8. The freewheeling current IW2 circulates through W2-phase winding 3W2 via diode D6 and switch T8. The constant current IU1 flows through U1-phase winding 3U1 via the switches T1 and T7.

FIG. 23 shows the demagnetization mode in the sub period E. In FIG. 23, the switches T1 and T7 are turned on, and the switch T8 is turned off. The demagnetizing current IW2 charges the DC power source (not shown) via DC link lines 1000 and 2000. Decreasing of the freewheeling current IU2 is slow. The constant current IU1 flows through U1-phase winding 3U1 via the switches T1 and T7. The magnetization mode and the demagnetization mode in sub periods A and C are essentially same as the magnetization mode and the demagnetization mode in sub periods E explained above.

According to the above dual Miller mode of the second embodiment, the magnetization mode and the demagnetization mode are executed alternately in each sub period with a predetermined frequency. Preferably, either of bridges 9A and 9B supplies both of the increasing current (magnetizing current) Ii and the decreasing current (demagnetizing current) Id. The other one of bridges 9A and 9B supplies the constant current Ic. For example, both of the increasing current Ii and the constant current Id are supplied with the PWM-switching. Thus, both of the magnetization of one phase and the demagnetization of another phase are executed well in each sub period. It is understand that each of executing times of the magnetization and the demagnetization in the dual Miller mode becomes half in comparison with a asymmetric bridge mode. However, the DC voltage applied to each of phase windings 3U1-3W2 becomes double. Accordingly, both of the magnetization speed and the demagnetization speed are not delayed by means of repeating the magnetization and the demagnetization alternately with a predetermined carrier frequency.

For example, the magnetization mode shown in FIG. 20 and the demagnetization mode shown in FIG. 21 are repeated alternately in each of sub periods D, F and B by means of PWM-switching the switch T7. U1-phase current IU1 becomes the freewheeling current in the magnetization mode because the switch T7 is turned off instead of turning-off of the switch T1. Thus, reduction of the U1-phase current IU1, which is the magnetizing current, is suppressed. The magnetization current IW2, which is the constant current Ic, is kept to a predetermined constant value by means of PWM-switching either or both of the upper switch T8 and the W2-phase lower switch T6.

Similarly, the magnetization mode shown in FIG. 22 and the demagnetization mode shown in FIG. 23 are repeated alternately in each of sub periods E, A and C by means of PWM-switching the switch T8. U2-phase current IU2 becomes the freewheeling current in the magnetization mode because the switch T8 is turned off instead of turning-off of the switch T2. Thus, reduction of the U2-phase current IU2, which is the magnetizing current, is suppressed. The magnetization current IU1, which is the constant current Ic, is kept to a predetermined constant value by means of PWM-switching either or both of the lower switch T7 and the U1-phase upper switch T1.

It is important that the demagnetization current is the largest at each initial time of sub periods A-F, and the magnetization current is the largest at each final time of sub periods A-F. Accordingly, controller 300 decreases a ratio Rt (=a demagnetization time Tde/a magnetization time Tma) continuously during each of sub periods A-F. Therefore, the average value of the magnetizing current and the average value of the demagnetizing current are not reduced by means of the above time-sharing operation. Thus, applying the full battery voltage applied to each phase in the dual Miller mode increases the average values of the magnetizing current and the demagnetizing current. In other words, the demagnetizing modes shown in FIGS. 21 and 23 are executed longer than the magnetizing modes shown in FIGS. 20 and 22 in each initial stage of sub periods A-F. The demagnetizing time becomes gradually short, and the magnetizing time becomes longer gradually.

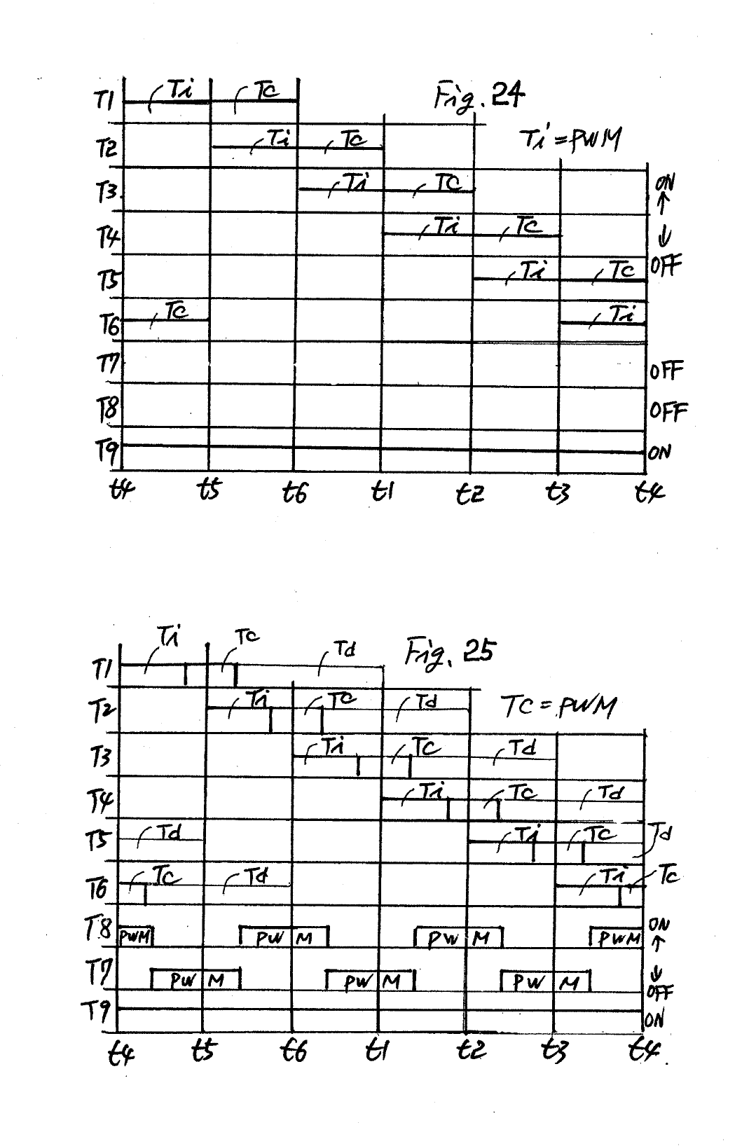

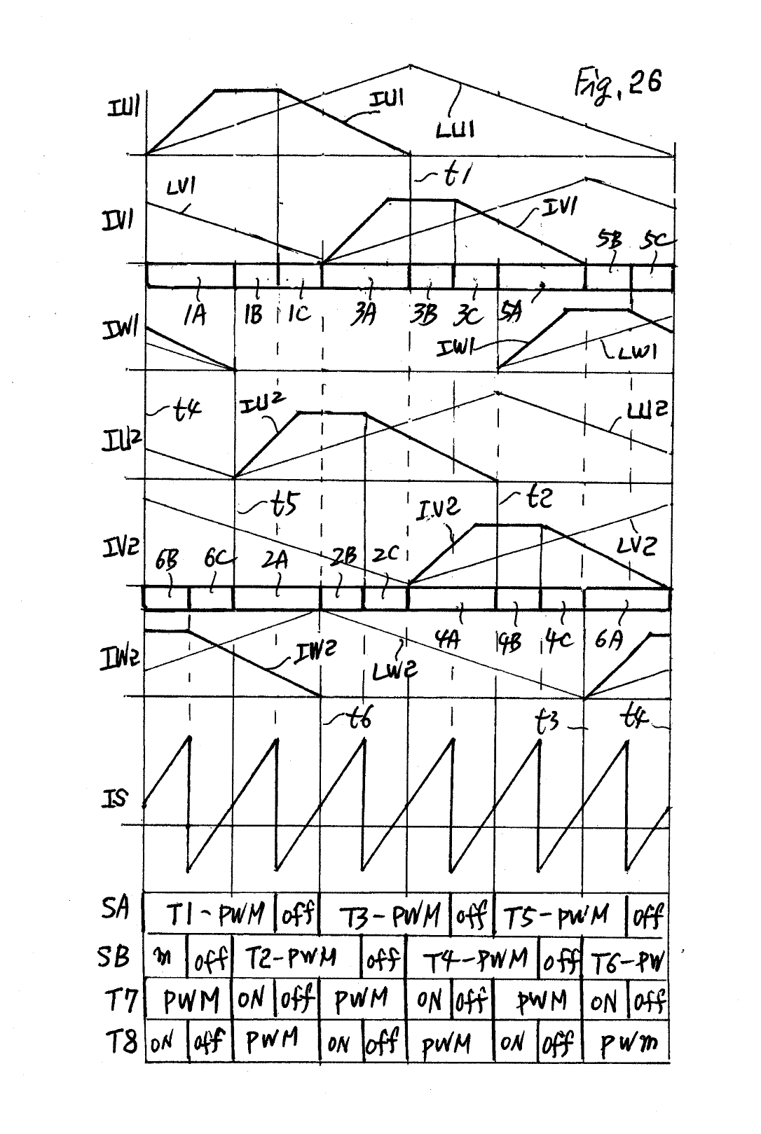

Switching patterns of switches T1-T9 in the above three modes are shown in FIGS. 24-26. FIG. 24 is a timing chart showing the switching pattern of the switches T1-T9 in the asymmetric bridge mode shown in FIG. 8. FIG. 25 is a timing chart showing the switching pattern of the switches T1-T9 in the accelerated bridge mode shown in FIG. 20. In FIGS. 24 and 25, the current-increasing period Ti and the constant current period Tc are executed in turn. In FIGS. 24 and 25, connection switch T9 is turned on.

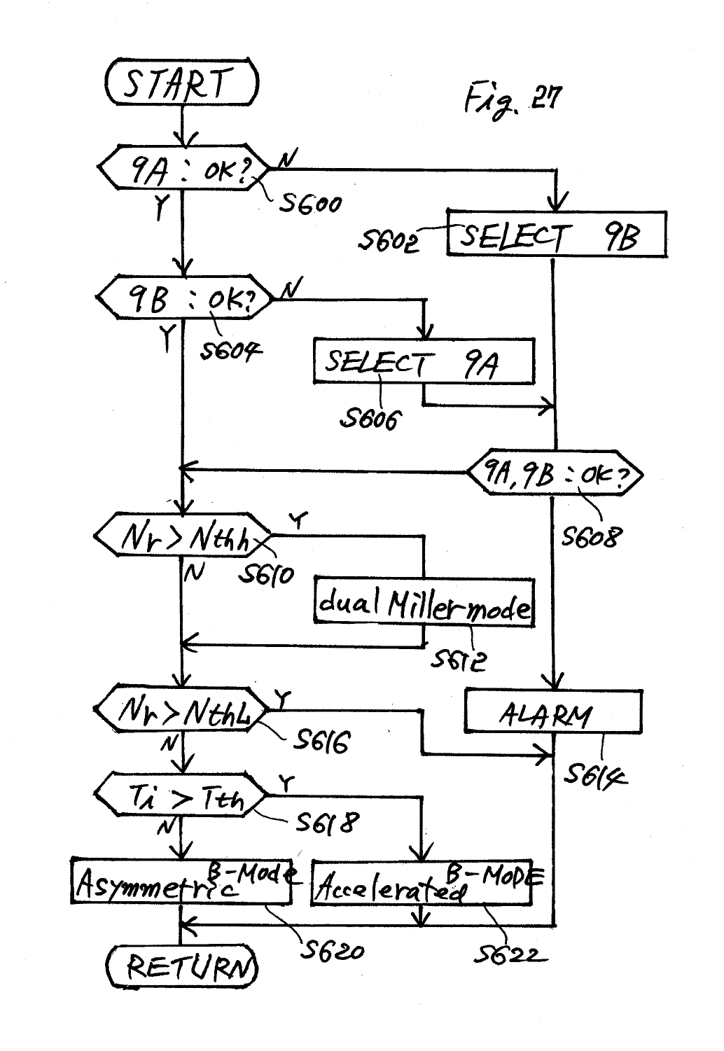

In FIG. 24, switches T1-T6 are PWM-switched during the current increasing period Ti. In FIG. 25, switches T1-T6 are PWM-switched during the constant current Tc. Further, the switches T7 and T8 are PWM-switched alternately. FIG. 26 is a timing chart showing switching pattern of the switches T1-T9 for executing the dual Miller mode. Power converter 9 produces two three-phase currents in the dual Miller mode. However, a current ripples IS of a total current supplied from the DC power source have the small amplitude and high frequency, because the two three-phase currents has a phase difference to each other. As the result, a smoothing capacitor connected to power converter 9 becomes small.

(A Mode-Changing Method)

The mode-changing method is explained referring to FIG. 27. FIG. 27 is a flow chart showing one example of the mode-changing method executed by controller 300. At a first step S600, it is judged whether or not upper bridge 9A is normal. If upper bridge 9A has a trouble, only lower bridge 9B is driven as the Miller converter at a step S602. In other words, the magnetization current is supplied from the switch T8 to one of three lower switches T2, T4 and T6 through the phase windings 3U2, 3V2 and 3W2.

At a next step S604, it is judged whether or not lower bridge 9B is normal. If lower bridge 9B has a trouble, only upper bridge 9A is driven as the Miller converter at a step S606. In other words, the magnetization current is supplied from one of three upper switches T1, T3 and T5 to the switch T7 through the phase windings 3U1, 3V1 and 3W1. Next, it is judged whether or not both of upper bridge 9A and lower bridge 9B are normal at a step 608. If both of upper bridge 9A and lower bridge 9B have a trouble each, bridges 9A and 9B are stopped, and the controller 300 outputs the alarm signal at a step 614.

Next, it is judged whether or not a detected rotor speed Nr is higher than a predetermined high threshold value Nrthh at a step S610. When the rotor speed Nr is higher than the high threshold value Nrthh, the dual Miller mode is executed at a step S612. The dual Miller mode is excellent for driving the SRM in the high-speed area because a full-scale of battery voltage is applied to each phase winding 3U1-3W2 each. In the high-speed area, phase currents IU1-IW2 of the sufficient value are supplied to phase windings 3U1-3W2 even though the back EMF is increased.

Next, it is judged whether or not a detected rotor speed Nr is higher than a predetermined high threshold value Nrthh at a step S610. When the rotor speed Nr is higher than the high threshold value Nrthh, the dual Miller mode is selected at a step S612. Further, it is judged whether or not a detected motor rotation speed Nr is lower than a predetermined low threshold value NrthL at a step S616. When the speed Nr is lower than the low threshold value NrthL, it is judged whether or not an instruction value of the motor torque Ti is larger than a predetermined value Tth as a step S618. When the instruction value of the motor torque Ti is not larger than the predetermined value Tth, the asymmetric bridge mode is executed at a step S620. When the instruction value of the motor torque Ti is larger than the predetermined value Tth, the accelerated bridge mode is executed at a step S622. The asymmetric bridge mode is excellent in the low speed area. The accelerated bridge mode is excellent in the low-speed-high-torque area.

### A First Arranged Embodiment

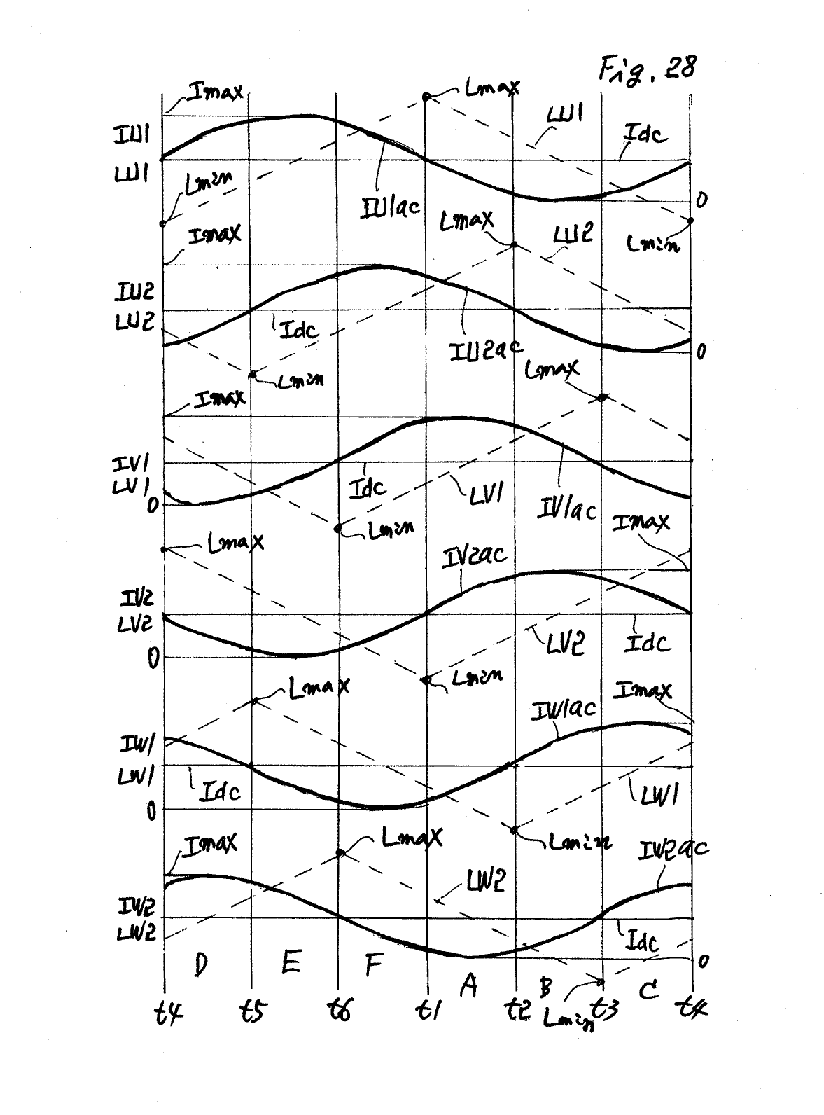

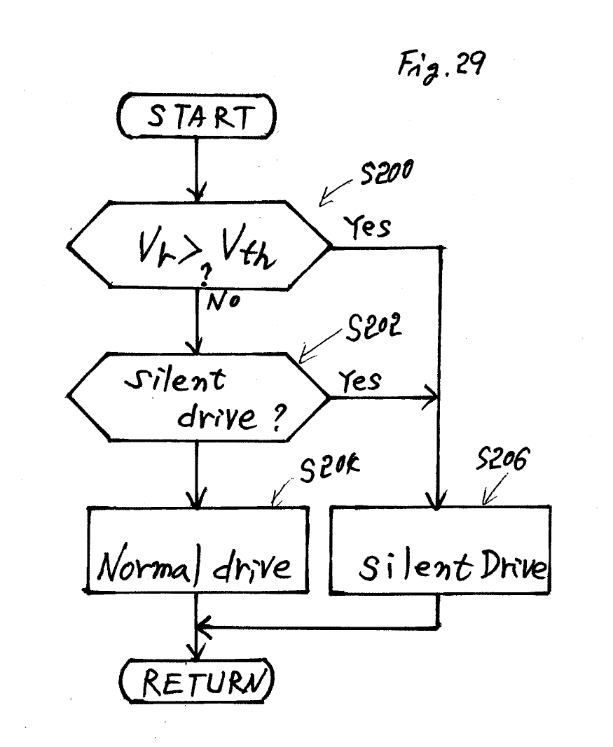

The first arranged embodiment is explained referring to FIGS. 28 and 29. FIG. 28 is a timing chart showing another configurations of phase currents IU1-IW2 in the dual Miller mode. U1-phase current IU1 is equal to a sum of a DC current Idc and a sinusoidal current IU1ac. U2-phase current IU2 is equal to a sum of the DC current Idc and a sinusoidal current IU2ac. V1-phase current IV1 is equal to a sum of a DC current Idc and a sinusoidal current IV1ac. V2-phase current IV2 is equal to a sum of the DC current Idc and a sinusoidal current IV2ac. W1-phase current IW1 is equal to a sum of a DC current Idc and a sinusoidal current IW1ac. W2-phase current IW2 is equal to a sum of the DC current Idc and a sinusoidal current IW2ac.

The configurations of phase currents IU1-IW2 are enable, when the dual-Miller mode is executed, because the sum of the first phase current and the third phase current is not equal to the second phase current. The configurations of phase currents IU1-IW2 shown in FIG. 28 is desirable for the high-speed area of the SRM because the iron loss of the SRM is reduced largely. The configurations of phase current IU1-IW2 are formed by means of PWM-switching of two phases.

FIG. 29 is a flow chart showing selection of the above sinusoidal configurations of phase currents IU1-IW2 shown in FIG. 28. First, it is judged whether or not a rotor rotation speed Vr is higher than a predetermined threshold value Vth at a step S200. When the rotor speed Vr is not higher, it is judged whether or not a driver hope a silent drive mode at a step S202. When the driver hopes a strong torque, the other current configuration is selected at a step S204. When the rotor speed Vr is higher or the driver hopes the silent driving, the current configuration shown in FIG. 28 is employed at a step S206. Instead of the current configuration shown in FIG. 28, the phase currents having half certificated sinusoidal waveforms shown in FIG. 16 can be employed in the silent drive mode at the step S206. For example, the phase currents of half certificated sinusoidal waveforms shown in FIG. 16 are employed the in a low speed area or in the asymmetric bridge mode or the accelerated bridge mode, and the phase currents consisting of the sum of DC current and sinusoidal AC current each are employed the in a high speed area or in the dual Miller mode. Therefore, the comfortable driving and high efficiency at the high speed are realized.

In the prior SRM-driving method, it is unknown to drive a switched reluctance motor (SRM) with phase currents having a sum of a DC current and a sinusoidal AC current. Further, it is unknown to reduce the iron loss by means of driving the SRM in the high speed area with a sum of a DC current and a sinusoidal AC current. The other SRM, for example the three-phase SRM, can be used the above SRM-driving method employing the sum of the DC current and the sinusoidal AC current.

### A Second Arranged Embodiment

The second arranged embodiment is explained referring to FIG. 30. The power converter 9 shown in FIG. 30 has a connection diode D9 instead of connection switch T9. Power converter 9 shown in FIG. 30 has mostly same motor-driving operation of as power converter 9 shown in FIG. 18. However, a current flows from upper neutral point NU to lower neutral point NL, when a voltage of upper neutral point NU is higher than a sum of a voltage of lower neutral point NL and a voltage drop of diode D9 in the dual Miller mode of FIG. 30. In other words, the currents of current-absorbing switch T7 and current-supplying switch T8 are reduced, when the voltage of upper neutral point NU is higher than the sum of the voltage of lower neutral point NL and the voltage drop of diode D9 in the dual Miller mode of FIG. 30.

### A Third Arranged Embodiment

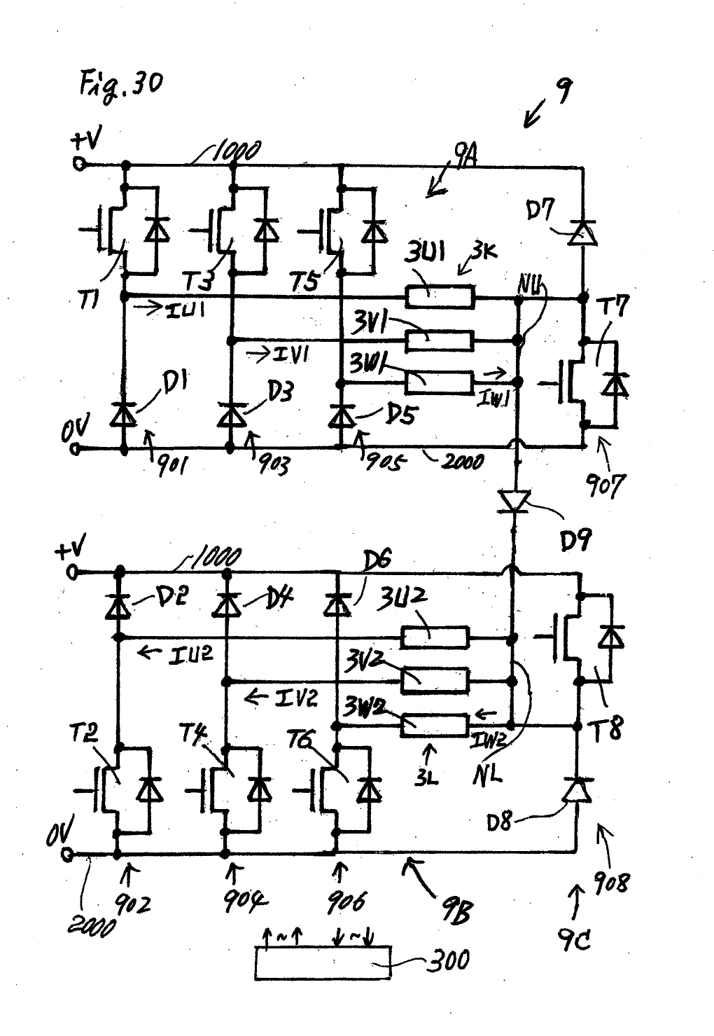

The third arranged embodiment is explained referring to FIG. 31. The power converter 9 shown in FIG. 31 has a connection diode D9 instead of connection switch T9. Further, the current-absorbing diode D7 and the current-supplying diode D8 are abbreviated in FIG. 31. However, the magnetization is accelerated by means of turning-on the switches T7 and T8 because the magnetizing currents flow through the switches T7 and T8.

### A Fourth Arranged Embodiment

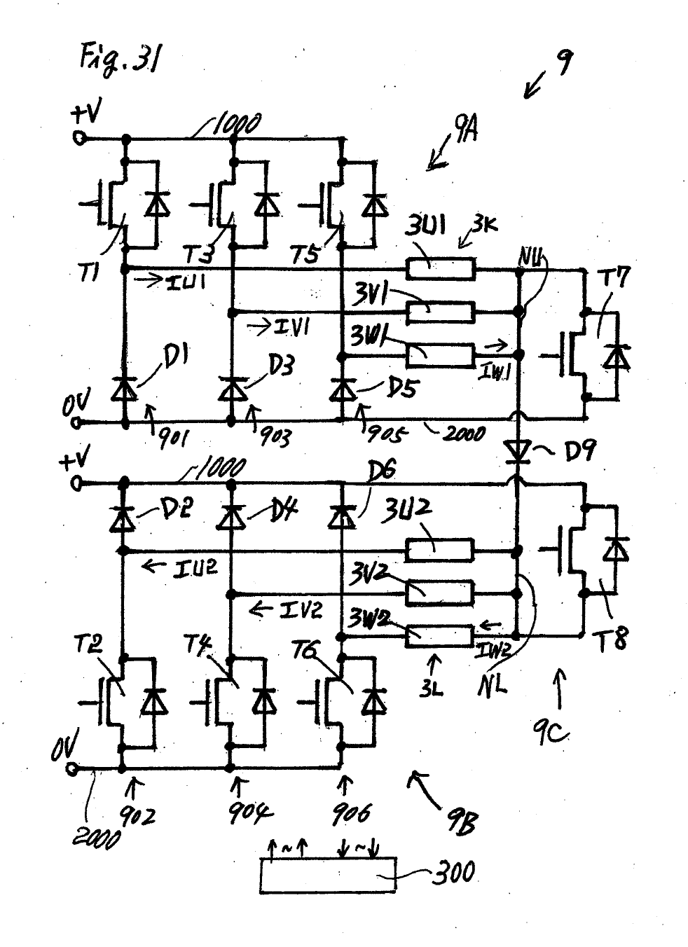

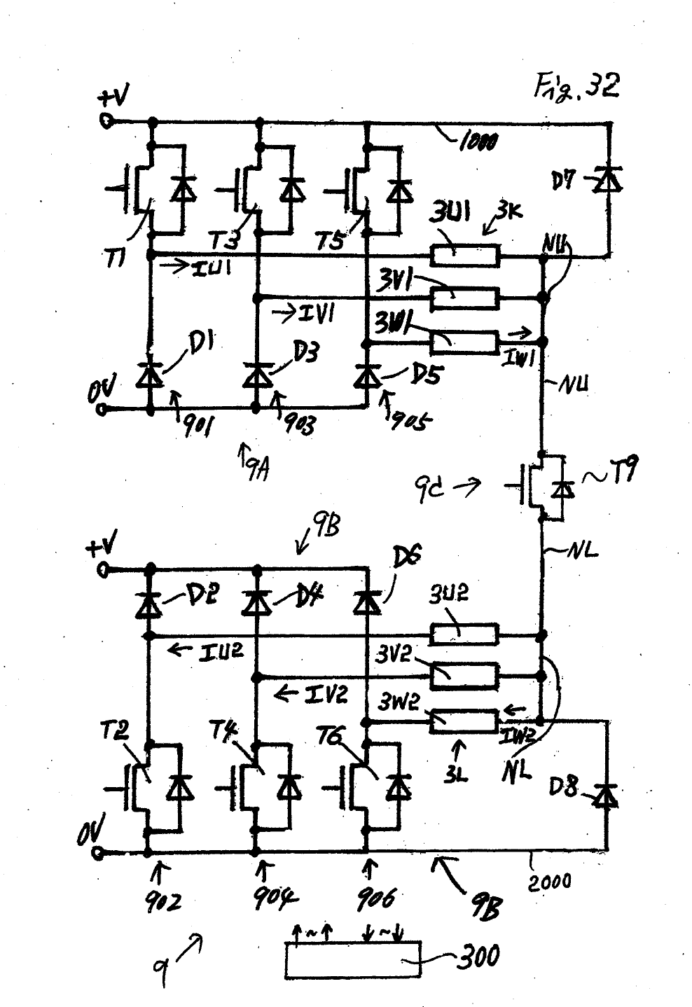

The fourth arranged embodiment is explained referring to FIG. 32. The switches T7 and T8 are abbreviated in FIG. 32. However, the demagnetization is accelerated by means of turning-off the connection switch T9 because the demagnetizing currents flow to the DC power source via the diodes D7 and D8.

### A Fifth Arranged Embodiment

The fifth arranged embodiment is explained referring to FIG. 33. In FIG. 33, connection switch T9 and diodes D7 and D8 are abbreviated in FIG. 33. However, the difference between the current of upper bridge 9A and the current of lower bridge 9B in the asymmetric bridge mode is absorbed by means of switching the switches T7 and T8.

### A Sixth Arranged Embodiment

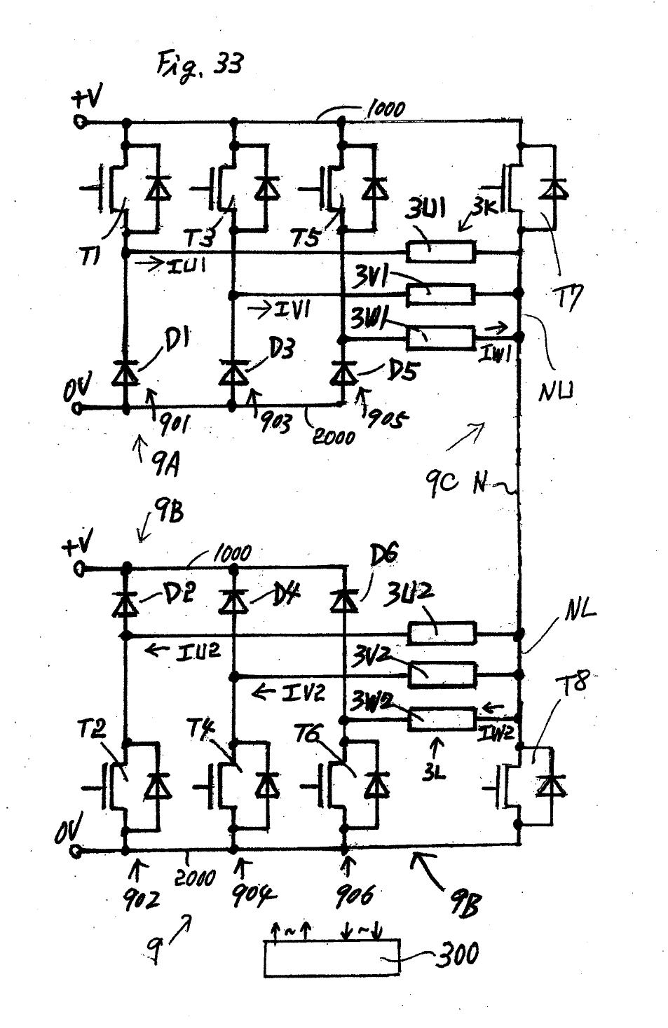

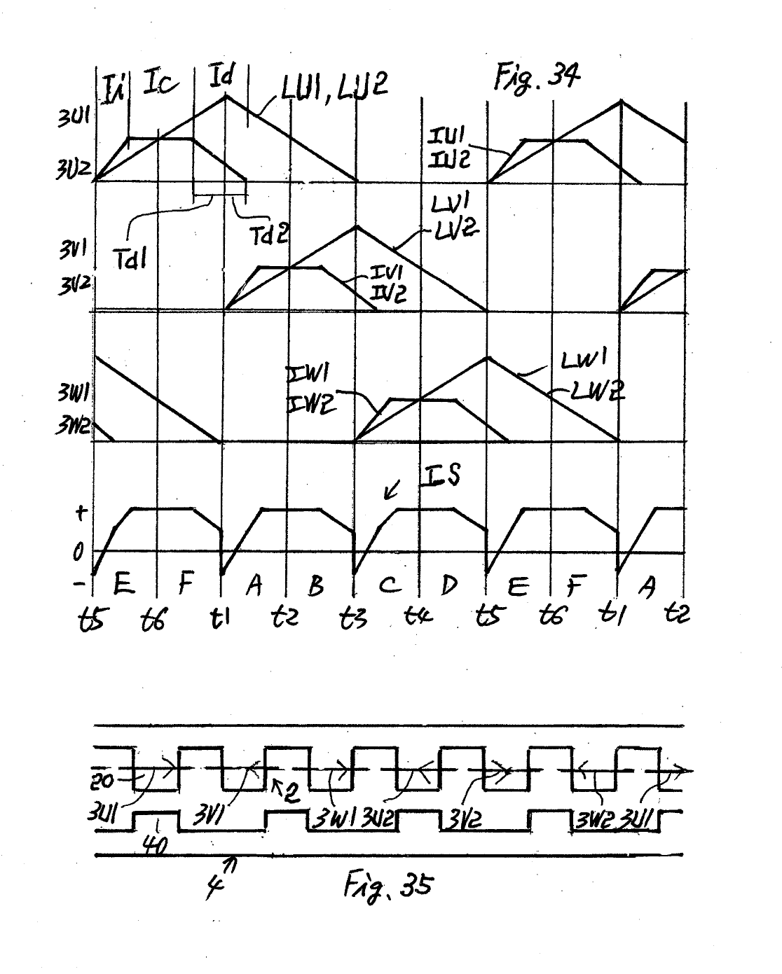

The sixth arranged embodiment is explained referring to FIGS. 34 and 35. FIG. 34 is a timing chart showing phase currents IU1-IW2 supplied to a popular three-phase SRM shown in FIG. 35. FIG. 35 is a schematic development showing the three-phase SRM of 6/4 type. Six phase windings 3U1-3W2 are wound six stator poles 20 respectively and in turn. The rotor core 4 has four rotor poles 40 per six stator poles 20. U1-phase current IU1 flowing through U1-phase winding 3U1 is the same as U2-phase current IU2 flowing through U2-phase winding 3U2. V1-phase current IV1 flowing through V1-phase winding 3V1 is the same as V2-phase current IV2 flowing through V2-phase winding 3V2. W1-phase current IW1 flowing through W1-phase winding 3W1 is the same as W2-phase current IW2 flowing through W2-phase winding 3W2.

The motor operation of the three-phase SRM is essentially same as the motor operation of the second embodiment shown in FIGS. 18-33. Accordingly, the three-phase SRM having six phase windings 3U1-3W2 connected to a common neutral point has the same advantages as the six-phase SRM mentioned above. However, U2-phase current IU2 has the same phase as U1-phase current IU1. V2-phase current IV2 has the same phase as V1-phase current IV1. W2-phase current IW2 has the same phase as W1-phase current IW1. In other words, the switches T1 and T2 have the same switching pattern. The switches T3 and T4 have the same switching pattern. The switches T5 and T6 have the same switching pattern.

Another difference between the three-phase operation shown in FIG. 34 and the six-phase operation shown in FIGS. 5-32 is explained referring to FIG. 34. The three-phase SRM of 6/4 type has a first current-decreasing period Td1 and a second current-decreasing period Td2 as shown in FIG. 34. In the first current-decreasing periods Td1 of the dual Miller mode, the two Miller converters execute only the demagnetizing operation each. In the second current-decreasing periods Td2 of the dual Miller mode, the two Miller converters execute the demagnetizing operation and the magnetizing operation alternately. The symmetric bridge mode is preferable in a low speed area. The dual Miller mode is preferable in a high speed area.

### A Seventh Arranged Embodiment

The seventh arranged embodiment is explained referring to FIGS. 36 and 37. FIG. 36 is a schematic development of another three-phase SRM with six stator poles 20 per eight rotor poles 40. Six phase windings 3U1-3W2 are wound on six stator poles 20 in turn and respectively. It is capable to wind two phase windings with the same phase on one stator pole. FIG. 37 is a timing chart showing phase currents IU1-IW2 supplied to phase windings 3U1-3W2 of the three-phase SRM shown in FIG. 36. The symmetric bridge mode is preferable in a low speed area. The dual Miller mode is preferable in a high speed area.

### A Eighth Arranged Embodiment

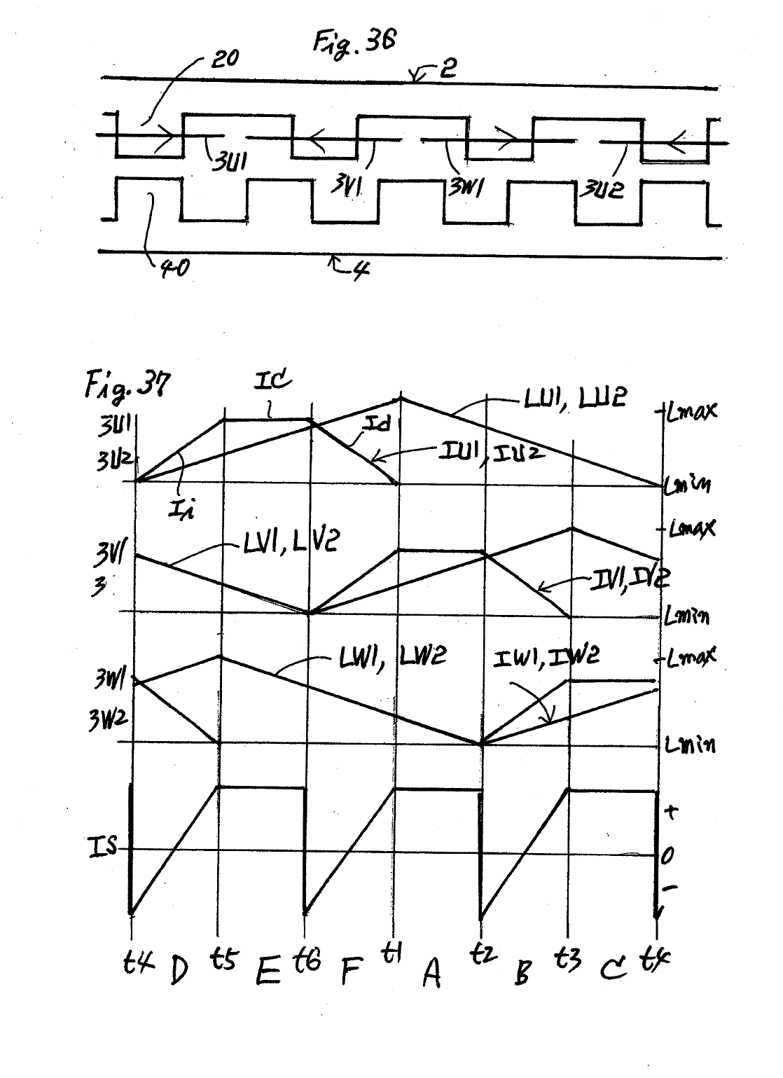

The eighth arranged embodiment is explained referring to FIGS. 38-40. FIG. 38 is a schematic cross-section showing a three-phase TFSRM having three single-phase TFSRMs arranged in tandem to an axial direction AX. Each of the three single-phase TFSRMs has each of rotor cores 4U-4W facing to each of stator cores 2U-2W. Each rotor core has the left teeth 40L and the right teeth 40R connected with a ring-shaped back core. Each stator core has the left teeth 20L and the right teeth 20R connected with a ring-shaped back core. Ring-shaped U-phase windings 3U1 and 3U2 are accommodated in a ring-shaped slot of U-phase stator cores 2U. Ring-shaped V-phase windings 3V1 and 3V2 are accommodated in a ring-shaped slot of V-phase stator cores 2U. Ring-shaped W-phase windings 3W1 and 3W2 are accommodated in a ring-shaped slot of W-phase stator cores 2W. The left rotor teeth 40L face the left stator teeth 20L in the radial direction RA. The right rotor teeth 40R face the right stator teeth 20R in the radial direction RA.

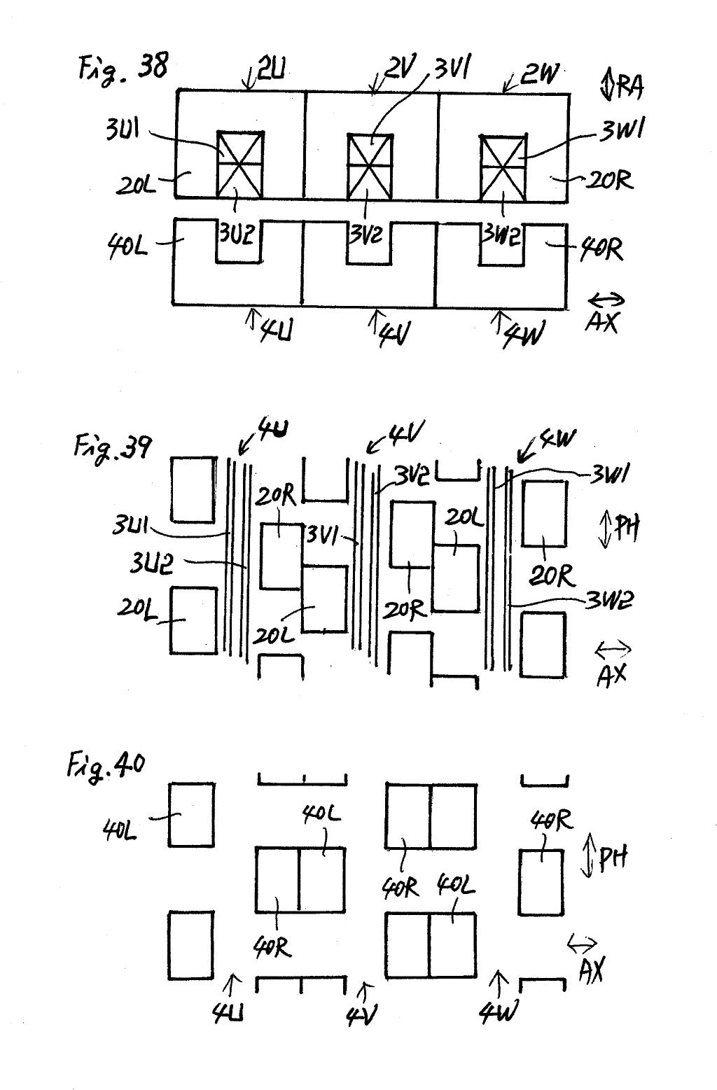

FIG. 39 is a circumferential development showing arrangement of stator teeth 20L and 20R. FIG. 40 is a circumferential development showing arrangement of rotor teeth 40L and 40R. The left stator teeth 20L, the right stator teeth 20R, the left rotor teeth 40L and the right rotor teeth 40R are arranged to the circumferential direction PH each.

Power converters 9 explained above is capable of driving the three-phase SRM shown in FIGS. 38-40. Configurations of phase currents IU1-IW2 are shown in FIG. 36. The symmetric bridge mode is preferable in a low speed area. The dual Miller mode is preferable in a high speed area.

### A Third Embodiment

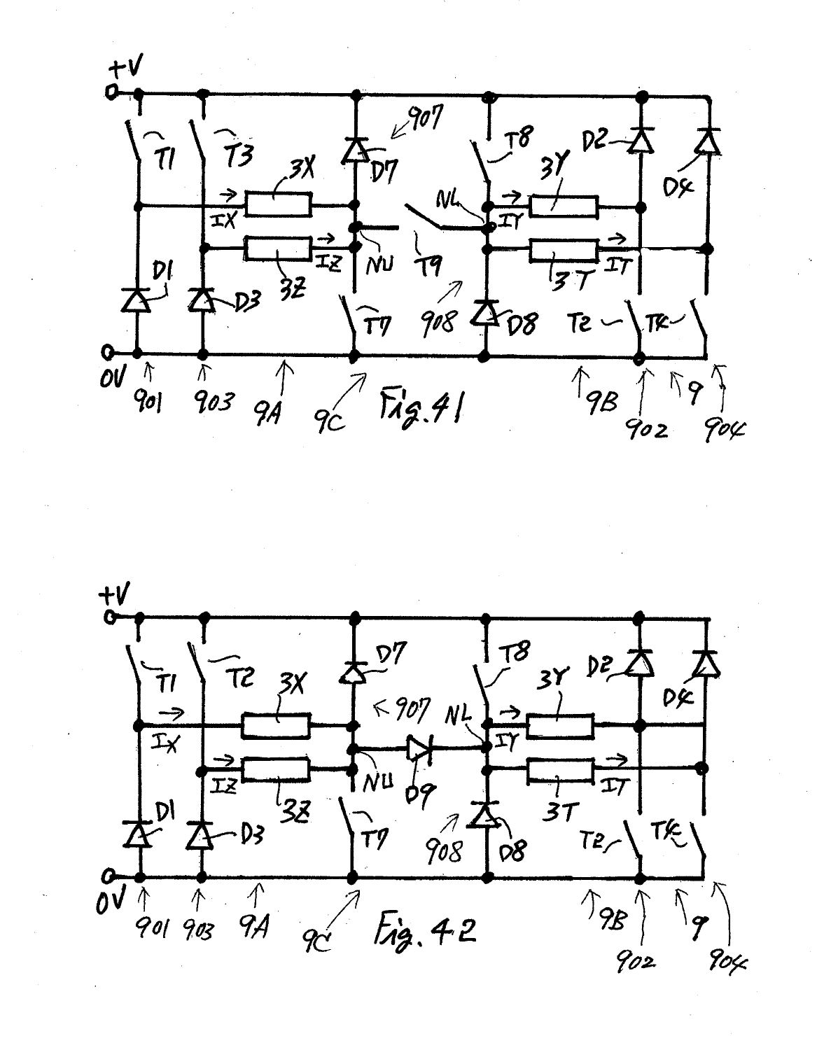

The third embodiment is explained referring to FIG. 41. FIG. 41 is a circuit topology configuration showing a four-phase power converter 9 for driving a four-phase SRM. The power converter 9 shown in FIG. 41 is essentially same as power converter 9 shown in FIG. 18. However, upper bridge 9A has only two legs 901 and 903 for driving X-phase winding 3X and Z-phase winding 3Z. Similarly, lower bridge 9B has only two legs 902 and 904 for driving Y-phase winding 3Y and T-phase winding 3T.

Four-phase power converter 9 shown in FIG. 41 can have the asymmetric bridge mode, the accelerated bridge mode and the dual Miller mode like the second embodiment explained above. Further, the power converter 9 shown in FIG. 41 is capable of supplying four-phase currents IX, IY, IZ and IT having the half rectified sinusoidal waveforms each. Moreover, the power converter 9 shown in FIG. 41 is capable of supplying each phase currents being equal to a sum of a DC current component and a sinusoidal AC current component. Both of amplitudes of the DC current component and the sinusoidal AC current component is equal. Therefore, four-phase power converter 9 shown in FIG. 41 has similar advantages to six-phase power converter shown in FIG. 18.

### A First Arranged Embodiment

The first arranged embodiment is explained referring to FIG. 42. Power converter 9 shown in FIG. 42 is essentially same as power converter 9 shown in FIG. 41. However, power converter 9 shown in FIG. 42 has connection diode D9 instead of connection switch T9 shown in FIG. 41. The operation and the advantages of power converter 9 shown in FIG. 42 is mostly same as power converter 9 shown in FIG. 30.

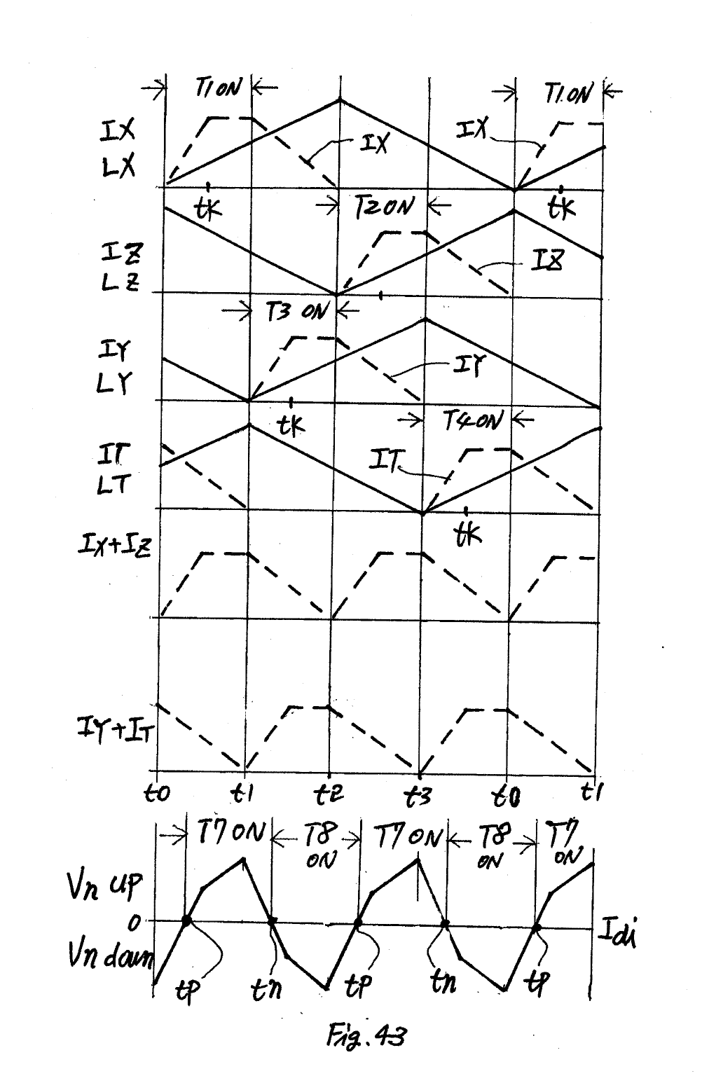

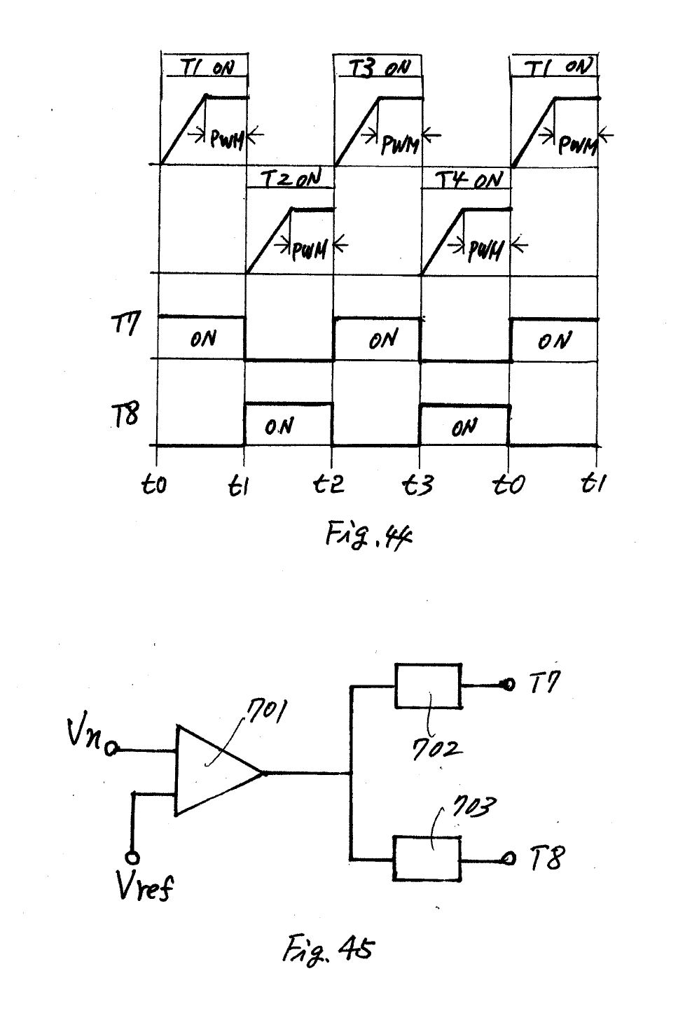

FIG. 44 is a timing chart showing phase currents IX-IT in the asymmetric mode of the power converter shown in FIG. 41 or FIG. 42. Each of phase currents IX-IT is PWM-switched from each time point tk in each of turning-on periods of the switches T1-T4. A voltage Vn of the neutral points Nu and NL becomes mostly a half of the DC link voltage Vdclink, when a sum of all currents IX, IY, IZ and IT becomes zero. Accordingly, it is capable of changing the turned-on of the switch T7 and the turned-on of the switch T8 at each time point when the sum of all phase currents IX, IY, IZ and IT becomes zero. FIG. 45 is a timing chart showing phase currents in the dual-Miller mode of the power converter shown in FIG. 41 or FIG. 42. FIG. 46 is a circuit topology configuration showing an example of changing the turned-on switch T7 and the turned-on switch T8 in accordance with the voltage Vn of the neutral points NU, NL in the asymmetric bridge mode shown in FIG. 43. A comparator 701 compares the voltage Vn and a reference voltage Vref(=0.5 Vdclink). A gate controller 702 turns on the switch T7, when the voltage Vn is higher than the reference voltage Vref. A gate controller 703 turns on the switch T8, when the voltage Vn is lower than the reference voltage Vref.

Six-phase power converters 9, which means a power converter having six legs connected to the neutral point, has been explained in the first embodiment and the second embodiment. Four-phase power converters 9 having four legs connected to the neutral point has been explained in the third embodiment. It is easily considered for a skilled engineer that the power converter 9 is capable of having more phases (more legs connected to the neutral point) in order to drive a SRM with more-phases. Further, it is considered easily that power converter 9 is capable of magnetizing a switched reluctance generator (SRG). Furthermore, power converter 9 can include the energy-absorber having a capacitor or a reactor in order to accumulate a residual magnetic energy temporarily. For example, it is capable that anode electrodes of lower diodes D1, D3, D5 can be connected to a capacitor capable of absorbing a current from the DC link line 2000 via a reactor or a switch. Similarly, cathode electrodes of upper diodes D2, D4, D6 are connected to a capacitor capable of supplying a current to the DC link line 1000 via a reactor or a switch. Further, diodes D1-D9 of power converter 9 can include transistors having essentially same rectification operation. Or, it is capable to connect transistors to diodes D1-D9 in parallel in order to reduce the diode power loss.

1. A power converter for driving a switched reluctance motor having four or six or more than six phase windings (3U1-3W2) of even number, wherein:
the power converter has an upper bridge (9A), a lower bridge (9B) and a controller (300);
the upper bridge (9A) has two or three or more than three of upper legs (901, 903, 905) connected to two or three or more than three of upper phase windings (3U1, 3V1, 3W1) connected to an upper neutral point (NU) each;
the lower bridge (9B) has two or three or more than three of lower legs (902, 904, 906) connected to two or three or three more than three of lower phase windings (3U2, 3V2, 3W2) connected to a lower neutral point (NL) each;
each of the upper legs (901, 903, 905) has a pair of a lower switch (T1, T3, T5) and an upper diode (D1, D3, D5) connected in series and supplies each of phase currents (IU1, IV1, IW1) to each of the upper phase windings (3U1, 3V1, 3W1);
each of the lower legs (902, 904, 906) has a pair of an upper switch (T2, T4, T6) and a lower diode (D2, D4, D6) connected in series and receives each of phase currents (IU2, IV2, IW2) from each of the lower phase windings (3U1, 3V1, 3W1);
the upper neutral point (NU) is connected to the lower neutral point (NL) directly or via at least one of a connection switch (T9) and a connection diode (D9); and
the power converter further has a current-adjusting circuit (9A, 9B, 300, T7-T9) including at least one switch (T1-T9) for reducing voltage ripples of the two neutral points (NU, NL) connected to each other.

2. The power converter according to claim 1, wherein the switched reluctance machine of radial flux type has three of the upper phase windings (3U1, 3V1, 3W1) and three of the lower phase windings (3U2, 3V2, 3W2);
each of the upper phase windings (3U1, 3V1, 3W1) magnetizes each of odd numbered stator poles (20) of the switched reluctance machine to a first magnetic polarity; and
each of the lower phase windings (3U2, 3V2, 3W2) magnetizes each of even numbered stator poles (20) of the switched reluctance machine to a second magnetic polarity.

3. The power converter according to claim 1, wherein the controller (900) has an asymmetric mode connecting the upper neutral point (NU) to the lower neutral point (NL);
the current-adjusting circuit is constituted by the upper bridge (9A), the lower bridge (9B) and the controller (300);
the upper bridge (9A) having three of odd numbered legs (901, 903, 905) supplies one phase current (IU1, IV1, IW1) being essentially equal to a sum of two phase currents (IU2, IV2, IW2) of the lower bridge (9B) in each of odd numbered sub periods (A, C, E) of the asymmetric mode; and
the lower bridge (9A) having three of even numbered legs (902, 904, 906) supplies one phase current (IU2, IV2, IW2) being essentially equal to a sum of two phase currents (IU1, IV1, IW1) of the upper bridge (9B) in each of even numbered sub periods (B, D, F) of the asymmetric mode.

4. The power converter according to claim 3, wherein the upper bridge (9A) supplies an increasing current of one phase and a decreasing current of another phase in each of the even numbered sub periods (B, D, F) of the asymmetric mode;
the lower bridge (9B) supplies an essentially constant current of another phase in each of the even numbered sub periods (B, D, F) of the asymmetric mode;
the upper bridge (9A) supplies an essentially constant current of one phase in each of the odd numbered sub periods (A, C, E) of the asymmetric mode; and
the lower bridge (9B) supplies an increasing current of another phase and a decreasing current of another phase in each of the odd numbered sub periods (A, C, E) of the asymmetric mode.

5. The power converter according to claim 1, wherein the upper bridge (9A) and the lower bridge (9B) supply each phase current with half rectified sinusoidal waveforms each to each phase winding (3U1, 3V1, 3W1, 3U2, 3V2, 3W2).

6. The power converter according to claim 1, wherein the current-adjusting circuit has a current-absorbing leg (907) and a current-supplying leg (908);
the current-absorbing leg (907) connected to the upper neutral point (NU) absorbs a current from the upper neutral point (NU) in order to reduce ripples of a voltage of the upper neutral point (NU); and
the current-supplying leg (908) connected to the lower neutral point (NL) supplies a current to the lower neutral point (NL) in order to reduce ripples of a voltage of the lower neutral point (NL).

7. The power converter according to claim 6, wherein the current-absorbing leg (907) has a current-absorbing switch (T7) for absorbing the current from the upper neutral point (NU); and
the current-supplying leg (908) has a current-supplying switch (T8) for supplying the current to the lower neutral point (NL).

8. The power converter according to claim 7, wherein the controller (300) has an accelerated bridge mode having an essentially equal voltage of the neutral points (NU, NL); and
the controller (300) switches the current-absorbing switch (T7) and the current-supplying switch (T8) in accordance with either of the voltage of the neutral points (NU, NL) or a current difference between the upper bridge (9A) and the lower bridge (9B) in the accelerated bridge mode in order to reduce the ripples of the voltage of the neutral points (NU, NL).

9. The power converter according to claim 1, wherein the controller (300) has a dual Miller mode when the connection switch (T9) is turned off;
the current-adjusting circuit has a current-absorbing leg (907) and a current-supplying leg (908);
the current-absorbing leg (907) has a current-absorbing switch (T7) and a current-absorbing diode (D7) connected in series;
the current-supplying leg (908) has a current-supplying switch (T8) and a current-supplying diode (D8) connected in series;
the upper bridge (9A) and the current-absorbing leg (907) constitute one Miller converter in the dual Miller mode; and
the lower bridge (9B) and the current-supplying leg (908) constitutes another Miller converter in the dual Miller mode.

10. The power converter according to claim 9, wherein the controller (300) selects the dual Miller mode, when the controller (300) detects a trouble of either of the upper bridge (9A) and the lower bridge (9B).

11. The power converter according to claim 9, wherein the controller (300) selects the dual Miller mode, when a detected rotation speed of the switched reluctance machine is higher than a predetermined value.

12. The power converter according to claim 9, wherein the controller (300) has both of a magnetizing mode for supplying a magnetizing current to one of the odd numbered windings (3U1, 3V1, 3W1) and a demagnetizing mode for supplying a demagnetizing current to another of the odd numbered windings (3U1, 3V1, 3W1) in the dual Miller mode;
the controller (300) has both of another magnetizing mode for supplying another magnetizing current to one of the even numbered windings (3U2, 3V2, 3W2) and another demagnetizing mode for supplying another demagnetizing current to another of the even numbered windings (3U2, 3V2, 3W2) in the dual Miller mode; and
the controller (300) executes the magnetizing mode and the demagnetizing mode alternately with a predetermined frequency.

13. The power converter according to claim 12, wherein the controller (300) executes the magnetizing mode and the demagnetizing mode of one of the two Miller converters alternately by means of switching the current-absorbing switch (T7) with a predetermined frequency; and
the controller (300) executes the magnetizing mode and the demagnetizing mode of another of the two Miller converters alternately by means of switching the current-supplying switch (T8) with a predetermined frequency.

14. The power converter according to claim 9, wherein the controller (300) has a silent drive mode supplying phase currents having a sum of a DC current component and a sinusoidal AC current component each; and
an amplitude of the DC current component is essentially equal to an amplitude of the sinusoidal AC current component.
